(19) United States
(12) Patent Application Publication
(10) Pub. No.: US 2024/0064665 A1
(43) Pub. Date: Feb. 22, 2024

(54) SYSTEM INFORMATION TRANSMISSION TECHNIQUES FOR ENERGY SAVING AND OVERHEAD REDUCTION

(71) Applicant: QUALCOMM Incorporated, San Diego, CA (US)

(72) Inventors: Navid Abedini, Basking Ridge, NJ (US); Iyab Issam Sakhnini, San Diego, CA (US); Wanshi Chen, San Diego, CA (US); Tao Luo, San Diego, CA (US)

(21) Appl. No.: 17/890,175

(22) Filed: Aug. 17, 2022

(51) Int. Cl. H04W 56/00; H04L 1/00; H04W 74/08

(52) U.S. Cl. CPC H04W 56/001; H04L 1/0003; H04W 74/0841

(57) ABSTRACT

Methods, systems, and devices for wireless communications are described in which a network entity may output one or more transmissions as part of a beam sweeping operation using transmission parameters that consume less power, less system resources, or both. One or more transmission parameters, such as a modulation and coding scheme, amount of occupied resources, or any combinations thereof, may have a first value on a first subset of the set of system information messages, and a different value on a different subset of the set of system information messages. A synchronization signal block (SSB) transmission associated with an instance of a system information message may provide an indication of the one or more transmission parameters of the system information message. A receiving device, such as a user equipment (UE) may attempt to decode the system information message based on the indication provided in the SSB.

### INTRODUCTION

The following relates to wireless communications, including techniques for management of energy and overhead.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a user equipment (UE) is described. The method may include receiving a synchronization signal block that indicates one or more parameters for a set of system information messages, the one or more parameters include at least a first parameter that indicates a first subset of the set of system information messages have a first transmission configuration and a second subset of the set of system information messages have a second transmission configuration and receiving a system information message from one of the first subset of the set of system information messages or the second subset of the set of system information messages based on a channel condition at the UE and the first parameter.

An apparatus for wireless communication at a UE is described. The apparatus may include a processor, and memory coupled with the processor, the processor configured to receive a synchronization signal block that indicates one or more parameters for a set of system information messages, the one or more parameters include at least a first parameter that indicates a first subset of the set of system information messages have a first transmission configuration and a second subset of the set of system information messages have a second transmission configuration and receive a system information message from one of the first subset of the set of system information messages or the second subset of the set of system information messages based on a channel condition at the UE and the first parameter.

Another apparatus for wireless communication at a UE is described. The apparatus may include means for receiving a synchronization signal block that indicates one or more parameters for a set of system information messages, the one or more parameters include at least a first parameter that indicates a first subset of the set of system information messages have a first transmission configuration and a second subset of the set of system information messages have a second transmission configuration and means for receiving a system information message from one of the first subset of the set of system information messages or the second subset of the set of system information messages based on a channel condition at the UE and the first parameter.

A non-transitory computer-readable medium storing code for wireless communication at a UE is described. The code may include instructions executable by a processor to receive a synchronization signal block that indicates one or more parameters for a set of system information messages, the one or more parameters include at least a first parameter that indicates a first subset of the set of system information messages have a first transmission configuration and a second subset of the set of system information messages have a second transmission configuration and receive a system information message from one of the first subset of the set of system information messages or the second subset of the set of system information messages based on a channel condition at the UE and the first parameter.

In some examples of the method, apparatuses, and non-transitory computer-readable medium described herein, the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof. In some examples of the method, apparatuses, and non-transitory computer-readable medium described herein, the receiving the system information message may include operations, features, means, or instructions for deferring an attempt to decode a first system information message of the first subset of information transmissions based on the channel condition at the UE being below a threshold value associated with the first parameter and decoding a second system information message of the second subset of information transmissions based on the channel condition at the UE being below the threshold value associated with the first parameter. In some examples of the method, apparatuses, and non-transitory computer-readable medium described herein, the first parameter may be a reference signal received power of a reference signal transmitted in the synchronization signal block.

In some examples of the method, apparatuses, and non-transitory computer-readable medium described herein, the receiving a synchronization signal block may include operations, features, means, or instructions for decoding a master information block from the synchronization signal block, where the first parameter is included in the master information block. In some examples of the method, apparatuses, and non-transitory computer-readable medium described herein, the first parameter is a flag that indicates an associated system information message is one of the first subset of the set of system information messages or the second subset of the set of system information messages.

Some examples of the method, apparatuses, and non-transitory computer-readable medium described herein may further include operations, features, means, or instructions for receiving an indication of a threshold value associated with the first parameter, and where the flag indicates that the associated system information message is to be decoded if the channel condition at the UE exceeds the threshold value. In some examples of the method, apparatuses, and non-transitory computer-readable medium described herein, the first parameter is received from a serving cell or from a neighbor cell, and where different values of the first parameter indicate that an associated system information message is one of the first subset of the set of system information messages or the second subset of the set of system information messages.

In some examples of the method, apparatuses, and non-transitory computer-readable medium described herein, the first subset of the set of system information messages is transmitted in a first subset of a set of time periods, is transmitted via a first subset of a set of beams, or any combinations thereof and the second subset of the set of system information messages is transmitted in a second subset of the set of time periods, is transmitted via a second subset of the set of beams, or any combinations thereof.

Some examples of the method, apparatuses, and non-transitory computer-readable medium described herein may further include operations, features, means, or instructions for receiving a control channel transmission associated with the system information message from one of the first subset of the set of system information messages or the second subset of the set of system information messages, where a first subset of control channel transmissions associated with the first subset of the set of system information messages has a first set of control channel parameter values, and a second subset of control channel transmissions associated with the second subset of the set of system information messages has a second set of control channel parameter values that are different than the first set of control channel parameter values.

In some examples of the method, apparatuses, and non-transitory computer-readable medium described herein, the set of system information messages include a first subset of the set of system information messages that each include a first quantity of system information parameters and a second subset of the set of system information messages each include a second quantity of system information parameters, and where the first quantity of system information parameters are different than the second quantity of system information parameters. In some examples of the method, apparatuses, and non-transitory computer-readable medium described herein, the first quantity of system information parameters is less than the second quantity of system information parameters, and provide system information for access control procedures, random access channel procedures, or any combinations thereof.

A method for wireless communication at a UE is described. The method may include receiving a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters, receiving a first system information message of the first subset of the set of system information messages, and transmitting a first channel access transmission based on one or more system information parameters of the first quantity of system information parameters.

An apparatus for wireless communication at a UE is described. The apparatus may include a processor, and memory coupled with the processor, the processor configured to receive a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters, receive a first system information message of the first subset of the set of system information messages, and transmit a first channel access transmission based on one or more system information parameters of the first quantity of system information parameters.

Another apparatus for wireless communication at a UE is described. The apparatus may include means for receiving a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters, means for receiving a first system information message of the first subset of the set of system information messages, and means for transmitting a first channel access transmission based on one or more system information parameters of the first quantity of system information parameters.

A non-transitory computer-readable medium storing code for wireless communication at a UE is described. The code may include instructions executable by a processor to receive a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters, receive a first system information message of the first subset of the set of system information messages, and transmit a first channel access transmission based on one or more system information parameters of the first quantity of system information parameters.

In some examples of the method, apparatuses, and non-transitory computer-readable medium described herein, the first subset of the set of system information messages is transmitted in a first subset of a set of time periods, is transmitted via a first subset of a set of beams, or any combinations thereof. In some examples of the method, apparatuses, and non-transitory computer-readable medium described herein, the first quantity of system information parameters is less than the second quantity of system information parameters, and provide system information for access control procedures, random access channel procedures, or any combinations thereof.

In some examples of the method, apparatuses, and non-transitory computer-readable medium described herein, the first subset of the set of system information messages provide an indication of a location of one or more of the second subset of the set of system information messages. Some examples of the method, apparatuses, and non-transitory computer-readable medium described herein may further include operations, features, means, or instructions for receiving configuration information that indicates the first subset of the set of system information messages and the second subset of the set of system information messages, the configuration information received in one or more of a master information block, a radio resource control transmission, a control information transmission, or any combinations thereof.

In some examples of the method, apparatuses, and non-transitory computer-readable medium described herein, the set of system information messages further include a third subset of the set of system information messages that each include a third quantity of system information parameters that are different than the first quantity of system information parameters and the second quantity of system information parameters, and where a combination of two or more of the first quantity of system information parameters, the second quantity of system information parameters, or the third quantity of system information parameters, provide a set of system information parameters.

In some examples of the method, apparatuses, and non-transitory computer-readable medium described herein, the one or more parameters include at least a first parameter that indicates a first subset of the set of system information messages have a first transmission configuration and a second subset of the set of system information messages have a second transmission configuration, and where the first system information message is received via one of the first subset of the set of system information messages or the second subset of the set of system information messages based on a channel condition at the UE and the first parameter. In some examples of the method, apparatuses, and non-transitory computer-readable medium described herein, the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof. In some examples of the method, apparatuses, and non-transitory computer-readable medium described herein, the first parameter is a reference signal received power of a reference signal transmitted in the synchronization signal block.

In some examples of the method, apparatuses, and non-transitory computer-readable medium described herein, the first subset of the set of system information messages is transmitted in a first subset of a set of time periods, is transmitted via a first subset of a set of beams, or any combinations thereof and the second subset of the set of system information messages is transmitted in a second subset of the set of time periods, is transmitted via a second subset of the set of beams, or any combinations thereof.

Some examples of the method, apparatuses, and non-transitory computer-readable medium described herein may further include operations, features, means, or instructions for receiving a control channel transmission associated with the first system information message, where a first subset of control channel transmissions associated with the first subset of the set of system information messages has a first set of control channel parameter values, and a second subset of control channel transmissions associated with the second subset of the set of system information messages has a second set of control channel parameter values that are different than the first set of control channel parameter values.

A method for wireless communication at a network entity is described. The method may include outputting a synchronization signal block that indicates one or more parameters for a set of system information messages, the one or more parameters include at least a first parameter that indicates a first subset of the set of system information messages have a first transmission configuration and a second subset of the set of system information messages have a second transmission configuration, outputting a first system information message of the first subset of the set of system information messages based on the first transmission configuration, and outputting a second system information message of the second subset of the set of system information messages based on the second transmission configuration.

An apparatus for wireless communication at a network entity is described. The apparatus may include a processor, and memory coupled with the processor, the processor configured to output a synchronization signal block that indicates one or more parameters for a set of system information messages, the one or more parameters include at least a first parameter that indicates a first subset of the set of system information messages have a first transmission configuration and a second subset of the set of system information messages have a second transmission configuration, output a first system information message of the first subset of the set of system information messages based on the first transmission configuration, and output a second system information message of the second subset of the set of system information messages based on the second transmission configuration.

Another apparatus for wireless communication at a network entity is described. The apparatus may include means for outputting a synchronization signal block that indicates one or more parameters for a set of system information messages, the one or more parameters include at least a first parameter that indicates a first subset of the set of system information messages have a first transmission configuration and a second subset of the set of system information messages have a second transmission configuration, means for outputting a first system information message of the first subset of the set of system information messages based on the first transmission configuration, and means for outputting a second system information message of the second subset of the set of system information messages based on the second transmission configuration.

A non-transitory computer-readable medium storing code for wireless communication at a network entity is described. The code may include instructions executable by a processor to output a synchronization signal block that indicates one or more parameters for a set of system information messages, the one or more parameters include at least a first parameter that indicates a first subset of the set of system information messages have a first transmission configuration and a second subset of the set of system information messages have a second transmission configuration, output a first system information message of the first subset of the set of system information messages based on the first transmission configuration, and output a second system information message of the second subset of the set of system information messages based on the second transmission configuration.

In some examples of the method, apparatuses, and non-transitory computer-readable medium described herein, the first transmission configuration and the second transmission configuration has at least one configuration element that is different, and the at least one configuration element includes one or more of a modulation and coding scheme, a quantity of occupied time resources, a quantity of occupied frequency resources, a transmission power, or any combinations thereof. In some examples of the method, apparatuses, and non-transitory computer-readable medium described herein, the first parameter is a reference signal received power of a reference signal transmitted in the synchronization signal block.

A method for wireless communication at a network entity is described. The method may include outputting a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters, outputting a first system information communication for the first subset of the set of system information messages, and obtaining a first channel access transmission based on one or more system information parameters of the first quantity of system information parameters.

An apparatus for wireless communication at a network entity is described. The apparatus may include a processor, and memory coupled with the processor, the processor configured to output a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters, output a first system information communication for the first subset of the set of system information messages, and obtain a first channel access transmission based on one or more system information parameters of the first quantity of system information parameters.

Another apparatus for wireless communication at a network entity is described. The apparatus may include means for outputting a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters, means for outputting a first system information communication for the first subset of the set of system information messages, and means for obtaining a first channel access transmission based on one or more system information parameters of the first quantity of system information parameters.

A non-transitory computer-readable medium storing code for wireless communication at a network entity is described. The code may include instructions executable by a processor to output a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters, output a first system information communication for the first subset of the set of system information messages, and obtain a first channel access transmission based on one or more system information parameters of the first quantity of system information parameters.

In some examples of the method, apparatuses, and non-transitory computer-readable medium described herein, the first subset of the set of system information messages is transmitted in a first subset of a set of time periods, is transmitted via a first subset of a set of beams, or any combinations thereof. In some examples of the method, apparatuses, and non-transitory computer-readable medium described herein, the first quantity of system information parameters is less than the second quantity of system information parameters, and provide system information for access control procedures, random access channel procedures, or any combinations thereof. In some examples of the method, apparatuses, and non-transitory computer-readable medium described herein, the first subset of the set of system information messages provide an indication of a location of one or more of the second subset of the set of system information messages.

### BRIEF DESCRIPTION OF THE DRAWINGS

FIG. 1 illustrates an example of a wireless communications system that supports system information transmission techniques for energy saving and overhead reduction in accordance with one or more aspects of the present disclosure.

FIG. 2 illustrates an example of a network architecture that supports system information transmission techniques for energy saving and overhead reduction in accordance with one or more aspects of the present disclosure.

FIG. 3 illustrates an example of a wireless communications system that supports system information transmission techniques for energy saving and overhead reduction in accordance with one or more aspects of the present disclosure.

FIG. 4 illustrates an example of synchronization signal block and system information messages for energy saving and overhead reduction in accordance with one or more aspects of the present disclosure.

FIG. 5 illustrates an example of synchronization signal block and system information messages for energy saving and overhead reduction in accordance with one or more aspects of the present disclosure.

FIG. 6 illustrates an example of a process flow that supports system information transmission techniques for energy saving and overhead reduction in accordance with one or more aspects of the present disclosure.

FIGS. 7 and 8 show block diagrams of devices that support system information transmission techniques for energy saving and overhead reduction in accordance with one or more aspects of the present disclosure.

FIG. 9 shows a block diagram of a communications manager that supports system information transmission techniques for energy saving and overhead reduction in accordance with one or more aspects of the present disclosure.

FIG. 10 shows a diagram of a system including a device that supports system information transmission techniques for energy saving and overhead reduction in accordance with one or more aspects of the present disclosure.

FIGS. 11 and 12 show block diagrams of devices that support system information transmission techniques for energy saving and overhead reduction in accordance with one or more aspects of the present disclosure.

FIG. 13 shows a block diagram of a communications manager that supports system information transmission techniques for energy saving and overhead reduction in accordance with one or more aspects of the present disclosure.

FIG. 14 shows a diagram of a system including a device that supports system information transmission techniques for energy saving and overhead reduction in accordance with one or more aspects of the present disclosure.

FIGS. 15 through 23 show flowcharts illustrating methods that support system information transmission techniques for energy saving and overhead reduction in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as NR systems, or other systems and radio technologies, including future systems and radio technologies not explicitly mentioned herein (e.g., sixth generation (6G) systems).

In some wireless communications systems, such as fifth generation (5G) systems, a relatively large amount of power may be consumed by network components in some situations. For example, a network entity, such as a radio unit (RU) or a radio head, in a system that uses beamformed communications may transmit multiple directional beams in multiple directions. Such systems may provide information for use by a UE to access the wireless communications system (e.g., system information (SI) that provides various parameters for system access, such as subcarrier spacing, a subcarrier offset between a synchronization signal block and overall resource block, a position of one or more downlink reference signals, a bandwidth for a downlink control channel, or any combinations thereof, for example) using beam sweeping techniques in which information is provided in multiple different transmissions in multiple different directions. For example, multiple instances of synchronization signal blocks (SSBs) and SI transmissions (e.g., remaining minimum system information (RMSI) transmissions that provide SI such as cell selection information, public land mobile network (PLMN) identification, tracking area code (TAC), cell identity, scheduling information for other system information, serving cell information, or any combinations thereof, for example) may be transmitted across multiple beams in multiple different directions according to a beam sweeping procedure. SSBs may be transmitted periodically by a network, and may include reference signals used for synchronization (e.g., primary synchronization signal (PSS) and secondary synchronization signal (SSS)), and a physical broadcast channel (PBCH) that carries parameters for decoding the RMSI (e.g., a control channel resource that carries RMSI, subcarrier spacing used for the control channel resource, and cell information, for example). Such beam sweeping techniques may consume additional power relative to techniques that do not use beam sweeping (e.g., information provided in a single omni-directional transmission may consume less power than transmission of multiple instances of the information in multiple different directions). Further, such beam sweeping transmissions may be transmitted using a transmit power and modulation and coding scheme (MCS) that is adapted to provide reliable decoding for all receiving devices (e.g., receiving UEs), including devices located at an edge of a coverage area of a transmitting device. The MCS may indicate, for example, a modulation order and coding rate for a RMSI communication, where a relatively low modulation order and a relatively low coding rate may be used in order to provide such reliable decoding for devices located at the edge of the coverage area. This may result in relatively high power consumption due to higher transmit power, relatively low coding rates in the associated MCS (e.g., resulting in a relatively long time duration to transmit and receive the RMSI communication), or both.

In accordance with various aspects discussed herein, techniques are provided in which a network entity may transmit one or more transmissions as part of a beam sweeping operation using transmission parameters that consume less power, less system resources, or both. In some aspects, one or more transmission parameters (e.g., MCS, transmission power, coding rate, modulation order, transport block size, or any combinations thereof) may be adjusted on a subset of downlink transmissions (e.g., a subset of a set of system information messages such as RMSI transmissions) to provide a reduction in an amount of power used for the downlink transmissions, a reduction in an amount of wireless resources used for the downlink transmissions, or any combinations thereof. The set of system information messages may include two or more system information messages, and may include a first subset of the set of system information messages that may include one or more system information messages and a second subset of information transmissions that may include one or more system information messages. In some examples, different instances of downlink transmissions (e.g., different RMSI transmissions in different subsets of system information messages) in time may be transmitted using higher MCSs and lower MCSs, where UEs with better channel quality can receive transmissions with the higher MCSs and UEs with lower channel quality (e.g., cell-edge UEs) can receive transmissions with lower MCSs. For example, different instances of RMSI across different beams may have different MCSs. As used herein, a system information message may be a separate message (e.g., a RMSI transmission or system information block (SIB) transmission), or incorporated into one or more other messages (e.g., one or more fields in one or more information blocks that are provided by a network entity). A system information message may be interchangeably referred to as a system information message, a system information transmission, a system information communication, system information signaling, or any similar terminology.

Additionally, or alternatively, a network entity may provide signaling, such as in a SSB transmission, that indicates whether RMSI is transmitted with higher or lower MCS (e.g., with a higher coding rate, modulation order, or both, that allows RMSI to be transmitted using fewer wireless resources relative to transmissions with a lower coding rate, modulation order, or both), which a UE can use to determine whether to attempt to decode a particular RMSI or not. In some cases, a channel condition at the UE (e.g., a reference signal received power (RSRP)) may be used to determine whether to attempt to decode a higher MCS RMSI, and in some cases the indication in the SSB may be an RSRP threshold for attempting to decode the associated RMSI. In some cases, the indication in SSB may be a flag that indicates the associated RMSI is transmitted with a higher or lower MCS. Further, in accordance with various aspects, similar techniques may be used for downlink control channel transmissions (e.g., physical downlink control channel (PDCCH) transmissions that provide information for decoding a physical downlink shared channel (PDSCH) transmission that contains the RMSI). In some cases, a master information block (MIB) provided with the SSB may provide an indication of the downlink control channel transmission parameters for different instances of a downlink control channel transmission.

Additionally, or alternatively, some system information messages (e.g., one or more instances of RMSI transmissions) may contain different amounts of parameters than other system information messages. For example, a “reduced RMSI” transmission (which may include a system information block (SIB) that may be referred to as a “light SIB1”) may include fewer RMSI parameters than other RMSI transmissions that include a full set of RMSI parameters. For example, the reduced RMSI may include a subset of the full set of RMSI parameters that only provide information needed for access control or random access channel (RACH) processes (e.g., cell selection information, signal quality thresholds for initiating RACH processes, cell access related information, serving cell configuration information). The full set of RMSI parameters, which may also be referred to as a complete set of RMSI parameters, may include, for example, information needed for access control or RACH processes, as well as cell selection information, PLMN identification, TAC, cell identity, scheduling information for other system information, and serving cell information.

Various techniques as discussed herein may provide one or more network enhancements and efficiencies. For example, a network entity may transmit some downlink transmissions (e.g., a first subset of system information messages) at a higher MCS than would otherwise be used to ensure cell-edge UE reception, and thus network power savings may be achieved through a shorter transmission duration. Further, providing some downlink transmissions using a MCS with a higher modulation order, higher coding rate, or both, may reduce an amount of wireless resources used to communicate system information relative to transmissions that use lower modulation order or lower coding rate, and thus may reduce overhead associated with system information messages. This may allow additional resources to be used for user data transmission, thus enhancing system efficiency and throughput, and providing an enhanced user experience.

Aspects of the disclosure are initially described in the context of wireless communications systems. Aspects of the disclosure are further illustrated by and described with reference to apparatus diagrams, system diagrams, SSB and system information transmission examples, process flows, and flowcharts that relate to system information transmission techniques for energy saving and overhead reduction.

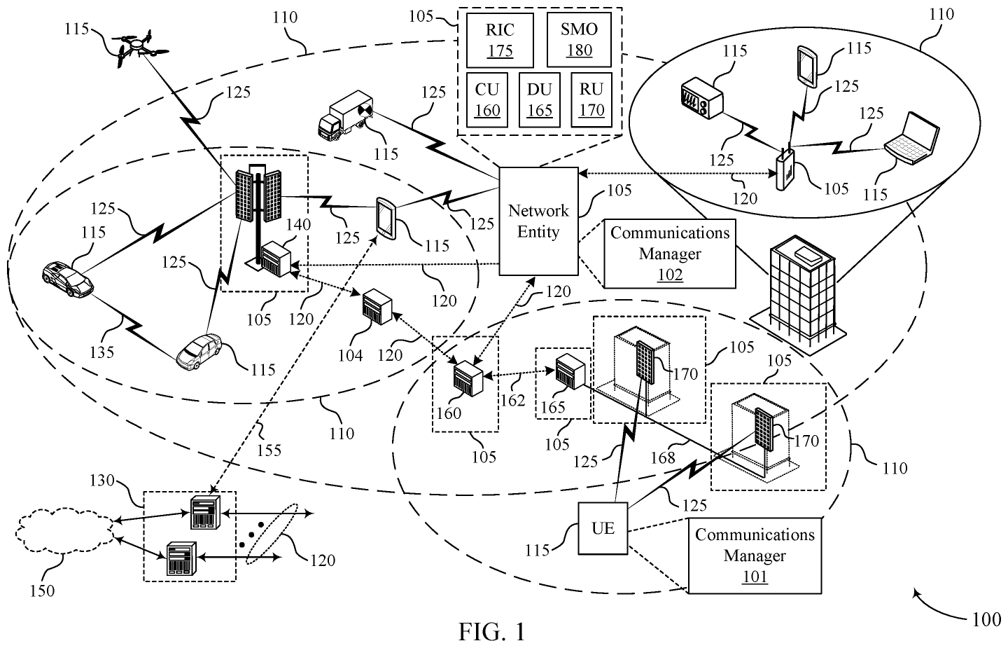

FIG. 1 illustrates an example of a wireless communications system 100 that supports system information transmission techniques for energy saving and overhead reduction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a network entity also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNB, a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support switching to an adaptive beam weight-based hybrid beamforming procedure as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz may be known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use digital precoding, beamforming, or a combination thereof to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., feedback associated with a multi-panel type codebook, a linear combination type codebook, a port selection type codebook). Although some techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, the wireless communications system 100 may be a millimeter wave (mmW) system. In some cases, a device (e.g., a UE 115, a network entity 105) may use a carrier frequency in the “28” and “29” GHz mmW bands to communicate with other devices in the wireless communications system 100. Additionally, or alternatively, the device may use a carrier frequency in upper mmW bands (e.g., greater than 52.6 GHz) for communications. Additionally, or alternatively, the device may use a carrier frequency in sub-Terahertz bands (e.g., greater than 114.25 GHz) for communications. In some examples, a device in the wireless communications system 100 may use analog or hybrid beamforming applications to steer energy in specific directions of beam space using one or more directional beams. Such analog or hybrid beamforming applications may be viewed as a static (e.g., directional beam) codebook approach, which may also be referred to as a codebook-based beamforming procedure.

In accordance with various aspects described herein, a network entity 105 may transmit one or more transmissions as part of a beam sweeping operation using transmission parameters that consume less power, less system resources, or both. In some aspects, one or more transmission parameters (e.g., MCS, transmission power, or any combinations thereof) may be adjusted on a subset of downlink transmissions (e.g., RMSI transmissions) to provide a reduction in an amount of power used for the downlink transmissions, a reduction in an amount of wireless resources used for the downlink transmissions, or any combinations thereof. In some examples, different instances of downlink transmissions (e.g., RMSI transmissions) in time may be transmitted using MCSs that have higher or lower coding rates, higher or lower modulation orders, or any combinations thereof, where UEs 115 with better channel quality can receive transmissions with the higher coding rates or modulation orders and UEs 115 with lower channel quality (e.g., cell-edge UEs 115) can receive transmissions with lower coding rates or modulation orders. For example, different instances of RMSI across different beams may have different MCSs.

Additionally, or alternatively, a network entity 105 may provide signaling, such as in a SSB transmission, that indicates whether RMSI is transmitted with higher or lower MCS, which a UE 115 can use to determine whether to attempt to decode a particular RMSI or not. In some cases, a channel condition at the UE 115 (e.g., a RSRP) may be used to determine whether to attempt to decode a higher MCS RMSI. Further, in accordance with various aspects, one or more downlink control channel transmissions (e.g., PDCCH transmissions that provide information for decoding a PDSCH transmission that contains the RMSI) may be transmitted with different MCSs. In some cases, a MIB provided with the SSB may provide an indication of the downlink control channel transmission parameters for different instances of a downlink control channel transmission.

In some further aspects, additionally, or alternatively, some system information messages (e.g., one or more instances of RMSI transmissions) may contain different amounts of parameters than other system information messages. For example, a reduced RMSI transmission may include fewer RMSI parameters than other RMSI transmissions that include a full set of RMSI parameters. For example, the reduced RMSI may include a subset of the full set of RMSI parameters that only provide information needed for access control or RACH processes.

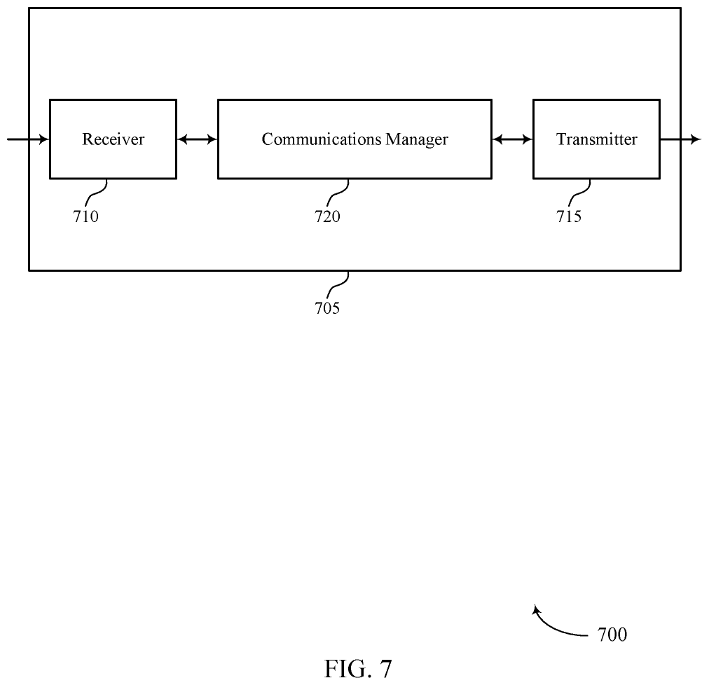

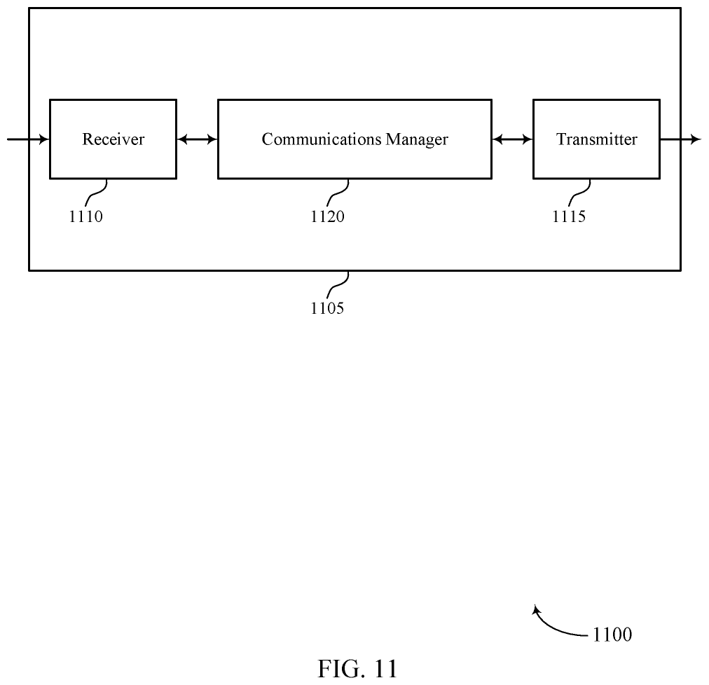

A UE 115 may include a communications manager 101 and a network entity 105 may include a communications manager 102 in accordance with examples as disclosed herein. The communications manager 101 may be an example of aspects of a communications manager as described with reference to FIGS. 7 through 10. The communications manager 102 may be an example of aspects of a communications manager as described with reference to FIGS. 11 through 14.

The communications manager 102 may output or transmit, and the communications manager 101 may receive or obtain, an SSB that provides an indication of one or more parameters for one or more associated system information messages. The communications manager 102 may output or transmit, and the communications manager 101 may receive or obtain, the associated system information in accordance with the one or more indicated parameters. In accordance with information provided in the one or more system information messages, the communications manager 101 and the communications manager 102 may exchange further signaling such that the UE 115 may effectively communicate with the network entity 105 or other communication devices in the wireless communications system 100 as described herein.

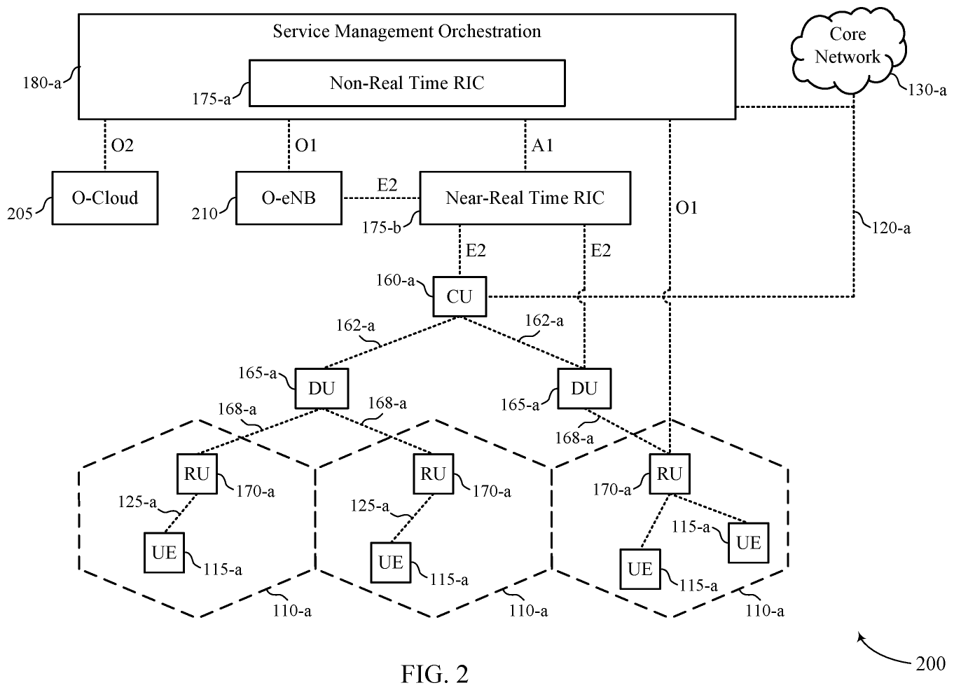

FIG. 2 illustrates an example of a network architecture 200 (e.g., a disaggregated base station architecture, a disaggregated RAN architecture) that supports system information transmission techniques for energy saving and overhead reduction in accordance with one or more aspects of the present disclosure. The network architecture 200 may be an example of a disaggregated base station architecture, a disaggregated RAN architecture, or both. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some examples, a UE 115-a may be concurrently served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based on the functional split, such as a lower-layer functional split. In such an architecture, an RU 170-a may be implemented to handle over the air (OTA) communication with one or more UEs 115-a. In some examples, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage thresholds which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some cases, the SMO 180-a may communicate with components configured in accordance with a 4G RAN (e.g., via an O1 interface). Additionally, or alternatively, in some examples, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or machine learning workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/machine learning models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or machine learning models to perform corrective actions through the SMO 180-a (e.g., reconfiguration via 01) or via generation of RAN management policies (e.g., A1 policies).

In some examples, the Non-RT RIC 175-a or the Near-RT RIC 175-b may adjust one or more parameters for a subset of downlink transmissions, such as a subset of the set of system information messages that are transmitted as part of a beam sweeping procedure. For example, one or more transmission parameters (e.g., MCS, transmission power, or any combinations thereof) may be adjusted differently on different subsets of downlink transmissions (e.g., RMSI transmissions) to provide a reduction in an amount of power used for the downlink transmissions, a reduction in an amount of wireless resources used for the downlink transmissions, or any combinations thereof. In some examples, different instances of downlink transmissions (e.g., RMSI transmissions) in time may be transmitted using MCSs having higher coding rates, higher modulation orders, or any combinations thereof, than other instances of the downlink transmissions. For example, different instances of RMSI across different beams may have different MCSs. Additionally, or alternatively, some system information messages (e.g., one or more instances of RMSI transmissions) may contain different amounts of parameters than other system information messages. For example, a reduced RMSI transmission may include fewer RMSI parameters than other RMSI transmissions that include a full set of RMSI parameters.

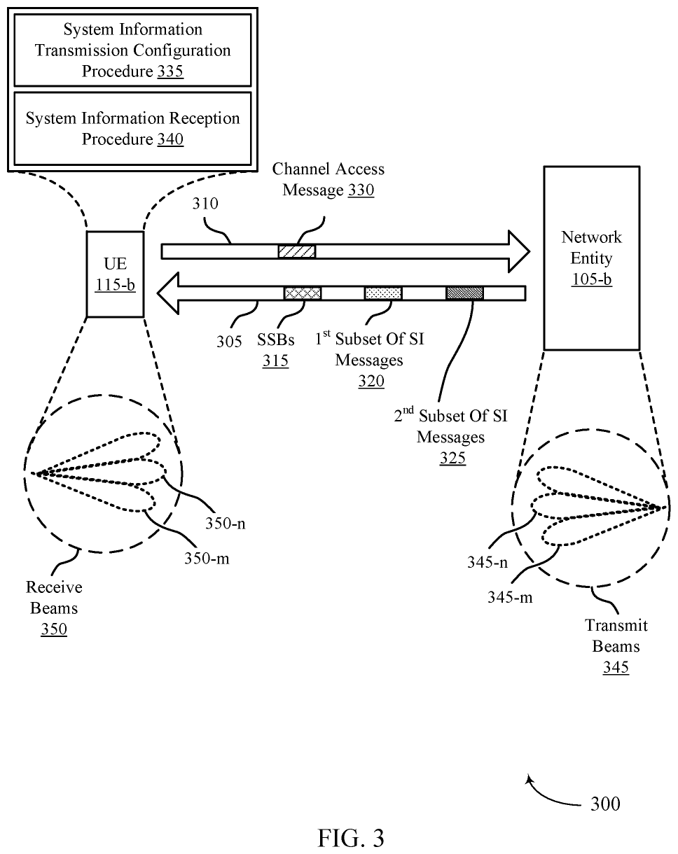

FIG. 3 illustrates an example of a wireless communications system 300 that supports system information transmission techniques for energy saving and overhead reduction in accordance with one or more aspects of the present disclosure. The wireless communications system 300 may implement or be implemented by aspects of the wireless communications system 100. For example, the wireless communications system 300 may include a network entity 105-b and a UE 115-b, which may be examples of a network entity 105 (e.g., an RU 170, a DU 165, a CU 160, a base station 140, or some combination thereof) and a UE 115 as described with reference to FIGS. 1 and 2. The network entity 105-b and the UE 115-b may communicate with one another via an uplink channel 305 and a downlink channel 310, which may be examples or components of a communication link 125 as described with reference to FIG. 1. The UE 115-b and network entity 105-b may support techniques for system information messages in which different instances of system information messages use different communications parameters (e.g., different MCSs). By managing the communications parameters of different system information messages, the UE 115-b and network entity 105-b may promote resource efficiency and reduced power consumption for the wireless communications system 300.

In the example of FIG. 3, the network entity 105-b may transmit a series of instances of SSBs 315 in accordance with a beam sweeping procedure using two or more transmit beams 345. The UE 115-b may monitor for one or more SSBs 315 in accordance with the beam sweeping procedure using two or more receive beams 350 (e.g., that are associated with corresponding transmit beams 345 based on channel reciprocity). Information from one or more detected SSBs 315, such as provided in a MIB transmitted in a physical broadcast channel (PBCH) via SSBs 315, may be used to determine one or more parameters for an associated system information message. In some cases, the SSBs 315 may indicate one or more parameters for a set of system information messages. The set of system information messages includes two or more system information messages, and the one or more parameters include at least a first parameter that indicates a first subset of one or more system information messages 320 have a first transmission configuration and a second subset of one or more system information messages 325 have a second transmission configuration. For example, the first parameter may be an indication provided in the MIB that the first subset of the set of system information messages 320 use a first MCS with one or more of a higher coding rate or modulation order than a second MCS used for the second subset of the set of system information messages 325. In some cases, a system information message configuration procedure 335 at the UE 115-b may identify the first parameter from one or more SSBs 315, and identify the associated MCS of a system information message associated with the SSB 315. In some cases, a system information reception procedure 340 at the UE 115-b may attempt to decode the associated system information message or defer decoding of the associated system information message, based on a measured channel condition at the UE 115-b. The UE 115-b, in some cases, may transmit a channel access transmission 330 based on system information provided in the first subset of the set of system information messages 320 or the second subset of the set of system information messages 325.

In some cases, the first subset of the set of system information messages 320 and the second subset of the set of system information messages 325 each include RMSI that is transmitted in accordance with a periodic beam-sweeping RMSI transmission procedure. Such beam-sweeping procedures may account for a relatively large energy consumption at the network entity 105-b, and may account for relatively large overhead (e.g., in coverage limited scenarios, RMSI such as SIB1 PDSCH may occupy up to 5% of resources). In accordance with various aspects, beam-specific RMSI parameters may be used for the first subset of the set of system information messages 320 and the second subset of the set of system information messages 325. For example, a first RMSI PDSCH of the first subset of the set of system information messages 320 for SSB n (e.g., that may be transmitted using transmit beam 345-n and that may be received using receive beam 350-n) may have a different MCS, a different number of symbols, a different number of resource elements, or any combinations thereof, than a second RMSI PDSCH of the second subset of the set of system information messages 325 for SSB m (e.g., that may be transmitted using transmit beam 345-m and that may be received using receive beam 350-m). In some cases, the first subset of the set of system information messages 320 may be used for beams in which a relatively large spatial coverage is unnecessary (e.g., for a beam direction in which UEs 115 will be relatively close due to a geographic feature or structure preventing UEs 115 from being farther away). Thus, such nonuniform spatial coverage results in RMSI on some beams does not need to reach as far as RMSI on other beams, and in some examples the different beams may be selected for the first subset of the set of system information messages 320 and the second subset of the set of system information messages 325 based on associated coverage targets in the corresponding beam directions. Additionally, in some cases different transmission parameters (e.g., different MCSs, different transmit powers, different coding rates, different modulation orders, different transport block sizes, etc.) for the first subset of the set of system information messages 320 and the second subset of the set of system information messages 325 may be adopted not necessarily due to a non-uniform spatial coverage region, but to provide opportunities for power savings, overhead reduction (e.g., based on fewer wireless resources that are used for the system information communications), or both.

In some implementations, the first subset of the set of system information messages 320 may be provided in a first subset of RMSI cycles or periods, and the second subset of the set of system information messages 325 may be provided in a second subset of RMSI cycles or periods, and the network entity 105-b may switch between different RMSI PDSCH configurations (e.g., different MCS, different number of occupied symbols or REs, or any combinations thereof) which may effectively result in different RMSI PDSCH coverages for the first subset of the set of system information messages 320 and the second subset of the set of system information messages 325. In some cases, during the cycles that have shorter PDSCH (e.g., due to higher MCS), the network entity 105-b may use less power and reduce overhead through a reduced RMSI PDSCH footprint. In such cases, if the UE 115-b is near an edge of the coverage area of the network entity 105-b, it may not be able to successfully receive the RMSI provided via the first subset of the set of system information messages 320, or may need to combine multiple copies of the RMSI in order to successfully decode the system information. Thus, in such cases, the UE 115-b may have increased power consumption and higher access latency. In accordance with some aspects, the SSBs 315 may provide signaling that indicates whether an associated RMSI transmission is in the first subset of the set of system information messages 320 or the second subset of the set of system information messages 325, and the UE 115-b may defer attempting to decode RMSI transmissions from the first subset of the set of system information messages 320.

In some aspects, for some beam directions and over time (e.g., across RMSI cycles/periods), the network entity 105-b may switch between different RMSI PDSCH configurations (e.g., between MCS, a number of occupied symbols or REs, or any combinations thereof) which may result in different RMSI PDSCH coverages. In some examples, the particular beam directions that are included in the first subset of the set of system information messages 320 and the second subset of the set of system information messages 325 may be selected based on one or more criteria, such as a density of UEs 115 in certain directions and distribution of coverage levels, a mobility level of UEs 115 in some directions (e.g., due to the characteristics of the environment), and the like. In some cases, the network entity 105-b may select different beams associated with the first subset of the set of system information messages 320 and the second subset of the set of system information messages 325 to reduce the power consumption and overhead in directions with relatively low mobility or low user density.

In some cases, as discussed herein, a balance between network entity 105-b power consumption and UE 115-b power consumption may be achieved by providing an indication that may allow the UE 115-b to determine the RMSI occasions where system information is more or less likely to be successfully decoded. In some cases, based on such an indication, the UE 115-b may defer attempting to decode RMSI from occasions of the first subset of the set of system information messages 320 based on a measured channel condition at the UE 115-b (e.g., if a RSRP measured from a SSB 315 transmission is below a threshold value). In cases where the UE 115-b defers attempting to decode RMSI, the UE 115-b may transition to a lower energy consumption state (e.g., an idle mode or sleep mode) until a subsequent cycle and avoid increased power consumption.

In accordance with some aspects, the network entity 105-b may include an indication with SSBs 315 that signals whether an associated system information message is in the first subset of the set of system information messages 320 or the second subset of the set of system information messages 325. In some cases, one or multiple RSRP thresholds (e.g., an RSRP threshold value for synchronization signals provided with SSBs 315) associated with the first subset of the set of system information messages 320 and the second subset of the set of system information messages 325. For example, system information transmitted in the first subset of the set of system information messages 320 (e.g., with high MCS) may be indicated to be associated to the case where the measured RSRP exceeds the indicated threshold value. In some cases, a bitmap may be provided in which each bit of the bitmap is associated with a beam or RMSI cycle and indicates whether the associated beam or RMSI cycle is in the first subset of the set of system information messages 320 or the second subset of the set of system information messages 325. In some cases, such a bitmap may be carried in a MIB. For example, a MIB sent in one cycle (and one direction) may carry information (e.g., an RSRP threshold) associated with the beam or that cycle. In such examples, MIB content changes over time or across beams. In other cases, signaling overhead may be reduced and a relative RSRP level (e.g., high RSRP or low RSRP) may be indicated instead of an actual threshold value, and the UE 115-b may decide its level based on the measured RSRP and a SSB link budget over a past time period at the UE 115-b may decide its level (e.g., an average SSB link budget observed over a prior 10 RMSI cycles). In some examples, two levels of RSRP may be associated with system information message occasions, with a first RSRP level (e.g., high RSRP) associated with the first subset of the set of system information messages 320 and a second RSRP level (e.g., low RSRP) associated with the second subset of the set of system information messages 325. In such two-level RSRP examples, a one-bit indication in the MIB may be sufficient to indicate the associated RMSI PDSCH configuration on the associated beam direction and/or cycle, and whether the associated system information occasion is in the first subset of the set of system information messages 320 or the second subset of the set of system information messages 325. In some further examples, RSRP levels of multiple cycles or beam directions may be provided in a bitmap. In some cases, the RSRP level signaling (e.g., a value of the RSRP threshold, a high/low indication, a bitmap indication, and the like) may be provides via a MIB sent by the network entity 105-b (e.g., for initial access), via dedicated RRC signaling or system information sent from the network entity 105-b (e.g., after a connection is established for future use), via dedicated RRC signaling or system information sent from a serving or camped cell for other neighbor cells (e.g., target cells), via a MAC control element (MAC-CE), or any combinations thereof.

Additionally, or alternatively, one or more control channel transmissions (e.g., PDCCH transmissions associated with a RMSI PDSCH transmission, referred to as a RMSI PDCCH) may have transmission parameters that are selected in accordance with techniques discussed herein. For example, RMSI PDCCH sent in different beam directions, in different RMSI cycles, or both, may have different configurations (e.g., in terms of number of RBs, number of symbols, offset to the SSB, a number of search space sets per slot, transmit power, numerology, etc.). In some cases, the configuration for RMSI PDCCH is carried in a MIB of the SSBs 315, and MIB sent in different directions, or different RMSI cycles, or both, may carry different content to provide different RMSI PDCCH configurations of the associated RMSI PDCCH. Additionally, or alternatively, one or more MIB sent in one direction and in a cycle may provide multiple configurations or indications associated with RMSI PDCCH in multiple beam directions or cycles. In some cases, the different RMSI PDCCH configuration information may be provided through other signaling, such as system information or dedicated RRC signaling (e.g., via an indication of a search space in a common PDCCH configuration, such as via searchSpaceSIB1 in PDCCH-ConfigCommon or via searchSpaceZero in PDCCH-ConfigCommon).

As discussed herein, in cases where RMSI is transmitted using parameters that reduce the associated coverage area of the RMSI transmission, a power consumption and access latency of the UE 115-b may be increased when the UE 115-b has relatively poor channel conditions. In accordance with some aspects, techniques are provided that may mitigate such additional power consumption and access latency. In some cases, if the UE 115-b seeks to identify a suitable cell and is unable to identify a suitable cell, it may seek to identify an acceptable cell. When a suitable cell is found or if only an acceptable cell is found, the UE 115-b may camp on that cell and commence the cell reselection procedure. For example, a suitable cell may be a measured cell with attributes that satisfy cell selection criteria; that has a cell PLMN is a selected PLMN, or a registered or an equivalent PLMN; that is not barred or reserved; and that is not part of a tracking area which is in a list of “forbidden tracking areas for roaming.” An acceptable cell may be a measured cell with attributes that satisfy the cell selection criteria; and that is not barred. In order to allow for enhanced cell selection in cases where UE 115-b has relatively poor channel conditions, and also allow for reduced power consumption at the network entity 105-b, the amount of system information (e.g., as part of RMSI) sent in different directions, RMSI cycles, or both, may be different (e.g., the amount of system information in the first subset of the set of system information messages 320 may be different from in the second subset of the set of system information messages 325). For example, the network entity 105-b may transmit a “light SIB1” or “reduced RMSI” in some beam directions, on some RMSI cycles, or both, and the network entity 105-b may provide a full SIB1 less frequently. In some cases, a light SIB1 may include the information needed for access control, RACH processes, or both, and may not include other information that is provided in a full SIB1. In some cases, the light SIB1 may provide information about when (e.g., which beams/cycles) the full SIB1 is provided. In some cases, a MIB, dedicated RRC, system information, or any combinations thereof, may indicate the network entity 105-b configuration related to light SIB1 and full SIB1 transmissions. In some aspects, this can be extended to multiple SIB1 levels (e.g., the full SIB1 may be divided into different SI blocks and different SI blocks are sent separately, such as with different periodicities). Examples of a full SIB1, which may be an example of a complete set of system information parameters, and a light SIB1 are provided below, in which the full SIB1 corresponds to a “ServingCellConfigCommonSIB,” and the light SIB1 includes only information that is required for RACH procedures:

Full SIB1 message

-- ASN1START
-- TAG-SIB1-START

| SIB1 ::= | SEQUENCE { | | |
|---|---|---|---|
| cellSelectionInfo | SEQUENCE { | | |
| q-RxLevMin | Q-RxLevMin, | | |
| q-RxLevMinOffset | INTEGER (1..8) | OPTIONAL, | -- Need S |
| q-RxLevMinSUL | Q-RxLevMin | OPTIONAL, | -- Need R |
| q-QualMin | Q-QualMin | OPTIONAL, | -- Need S |
| q-QualMinOffset | INTEGER (1..8) | OPTIONAL | -- Need S |

}

| OPTIONAL, -- | Cond Standalone | | |
|---|---|---|---|
| cellAccessRelatedInfo | CellAccessRelatedInfo, | | |
| connEstFailureControl | ConnEstFailureControl | OPTIONAL, | -- Need R |
| si-SchedulingInfo | SI-SchedulingInfo | OPTIONAL, | -- Need R |

| | | |
|---|---|---|
| servingCellConfigCommon | ServingCellConfigCommonSIB | OPTIONAL, -- |

Need R

| | | | | |
|---|---|---|---|---|
| ims-EmergencySupport | ENUMERATED | {true} | OPTIONAL, | -- Need R |
| eCallOverIMS-Support | ENUMERATED | {true} | OPTIONAL, | -- Need R |

| ue-TimersAndConstants | UE-TimersAndConstants | OPTIONAL, | -- Need R |
|---|---|---|---|
| uac-BarringInfo | SEQUENCE { | | |
| uac-BarringForCommon | UAC-BarringPerCatList | OPTIONAL, | --Need S |
| uac-BarringPerPLMN-List | UAC-BarringPerPLMN-List | OPTIONAL, | --Need S |

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN) ) OF UAC- |

AccessCategory1-SelectionAssistanceInfo

| } | | OPTIONAL | -- Need S |
|---|---|---|---|
| } | | OPTIONAL, | -- Need R |
| useFullResumeID | ENUMERATED {true} | OPTIONAL, | -- Need R |

| | | |
|---|---|---|
| lateNonCriticalExtension | OCTET STRING | OPTIONAL, |
| nonCriticalExtension | SIB1-v1610-IEs | OPTIONAL |

}

| SIB1-v1610-IEs ::= | SEQUENCE { | | |
|---|---|---|---|
| idleModeMeasurementsEutra-r16 | ENUMERATED{true} | OPTIONAL, | -- Need R |
| idleModeMeasurementsNR-r16 | ENUMERATED{true} | OPTIONAL, | -- Need R |
| posSI-SchedulingInfo-r16 | PosSI-SchedulingInfo-r16 | OPTIONAL, | -- Need R |

| | | |
|---|---|---|
| nonCriticalExtention | SIB1-v1630-IEs | OPTIONAL |

}

| | |
|---|---|
| SIB1-v1630-IEs ::= | SEQUENCE { |
| uac-BarringInfo-v1630 | SEQUENCE { |

| | |
|---|---|
| uac-AC1-SelectAssistInfo-r16 | SEQUENCE (SIZE (2..maxPLMN) ) OF |

UAC-AC1-SelectAssistInfo-r16

| | | |
|---|---|---|
| } | OPTIONAL, | -- Need R |

| | | |
|---|---|---|
| nonCriticalExtension | SIB1-v1700-IEs | OPTIONAL |

}

| SIB1-v1700-IEs ::= | SEQUENCE { | | |
|---|---|---|---|
| hsdn-Cell-r17 | ENUMERATED {true} | OPTIONAL, | -- Need R |

| | |
|---|---|
| uac-BarringInfo-v1700 | SEQUENCE { |

| | |
|---|---|
| uac-BarringInfoSetList-v1700 | UAC-BarringInfoSetList-v1700 |

| } | | OPTIONAL, | -- Cond MINT |
|---|---|---|---|
| sdt-ConfigCommon-r17 | SDT-ConfigCommonSIB-r17 | OPTIONAL, | -- Need R |

| | | |
|---|---|---|
| redcap-ConfigCommon-r17 | RedCap-ConfigCommonSIB-r17 | OPTIONAL, -- |

Need R

| featurePriorities-r17 | SEQUENCE { | | |
|---|---|---|---|
| redCapPriority-r17 | FeaturePriority-r17 | OPTIONAL, | -- Need R |
| slicingPriority-r17 | FeaturePriority-r17 | OPTIONAL, | -- Need R |

| | | |
|---|---|---|
| msg3-Repetitions-Priority-r17 | FeaturePriority-r17 | OPTIONAL, |

| | | | -- Need R |
|---|---|---|---|
| sdt-Priority-r17 | FeaturePriority-r17 | OPTIONAL | -- Need R |
| } | | OPTIONAL, | -- Need R |
| si-SchedulingInfo-v1700 | SI-SchedulingInfo-v1700 | OPTIONAL, | -- Need R |
| hyperSFN-r17 | BIT STRING (SIZE (10) ) | OPTIONAL, | -- Need R |
| eDRX-AllowedIdle-r17 | ENUMERATED {true} | OPTIONAL, | -- Need R |
| eDRX-AllowedInactive-r17 | ENUMERATED {true} | OPTIONAL, | -- Cond EDRX-RC |

| | |
|---|---|
| intraFreqReselectionRedCap-r17 | ENUMERATED {allowed, notAllowed} |

| | |
|---|---|
| OPTIONAL, | -- Need S |

| | |
|---|---|
| cellBarredNTN-r17 | ENUMERATED {barred, notBarred} |

| | |
|---|---|
| OPTIONAL, | -- Need S |

| | | |
|---|---|---|
| nonCriticalExtension | SEQUENCE { } | OPTIONAL |

}

| UAC-AccessCategory1-SelectionAssistanceInfo ::= | | ENUMERATED {a, b, c} |
|---|---|---|
| UAC-AC1-SelectAssistInfo-r16 ::= | ENUMERATED | {a, b, c, notConfigured} |

| | |
|---|---|
| SDT-ConfigCommonSIB-r17 ::= | SEQUENCE { |

| | | | |
|---|---|---|---|
| sdt-RSRP-Threshold-r17 | RSRP-Range | OPTIONAL, | -- Need R |

| | |
|---|---|
| sdt-LogicalChannelSR-DelayTimer-r17 | ENUMERATED { sf20, sf40, sf64, |
| | sf128, sf512, |
| | sf1024, sf2560, spare1} |

| | |
|---|---|
| OPTIONAL, | -- Need R |

| | |
|---|---|
| sdt-DataVolumeThreshold-r17 | ENUMERATED {byte32, byte100, |
| | byte200, byte400, |
| | byte600, byte800, byte1000, |
| | byte2000, byte4000, |
| | byte8000, byte9000, |
| | byte10000, byte12000, |
| | byte24000, byte48000, |
| | byte96000}, |
| t319a-r17 | ENUMERATED { ms100, ms200, |
| | ms300, ms400, ms600, |
| | ms1000, ms2000, ms3000, ms4000, |
| | spare7, spare6, |
| | spare5, spare4, spare3, spare2, |
| | spare1} |

}
RedCap-ConfigCommonSIB-r17 ::= SEQUENCE {

| | | | |
|---|---|---|---|
| halfDuplexRedCapAllowed-r17 | ENUMERATED {true} | OPTIONAL, | -- Need R |

| | |
|---|---|
| cellBarredRedCap-r17 | SEQUENCE { |

| | |
|---|---|
| cellBarredRedCap1Rx-r17 | ENUMERATED {barred, notBarred}, |
| cellBarredRedCap2Rx-r17 | ENUMERATED {barred, notBarred} |

```
      }
OPTIONAL, -- Need R
  ...
}
FeaturePriority-r17 ::= INTEGER (0..7)
-- TAG-SIB1-STOP
-- ASN1STOP
```

Light SIB1 message

-- ASN1START
-- TAG-SIB1-START

| LIGHT-SIB1 ::= | SEQUENCE { | | |
|---|---|---|---|
| cellSelectionInfo | SEQUENCE { | | |
| q-RxLevMin | Q-RxLevMin, | | |
| q-RxLevMinOffset | INTEGER (1..8) | OPTIONAL, | -- Need S |
| q-RxLevMinSUL | Q-RxLevMin | OPTIONAL, | -- Need R |
| q-QualMin | Q-QualMin | OPTIONAL, | -- Need S |
| q-QualMinOffset | INTEGER (1..8) | OPTIONAL | -- Need S |

| | | |
|---|---|---|
| } | OPTIONAL, | -- Cond Standalone |

| cellAccessRelatedInfo | CellAccessRelatedInfo, | |
|---|---|---|
| servingCellConfigCommon | ServingCellConfigCommonSIB | OPTIONAL, -- |

Need R
-- TAG-SIB1-STOP
-- ASN1STOP

Such techniques thus provide sufficient information at a particular RMSI periodicity to allow UE 115-b to perform a channel access procedure and have a reduced access latency relative to cases where RMSI is able to be received with a reduced periodicity. Further, such techniques also allow the network entity 105-b to have reduced power consumption and reduced overhead relative to cases where a full SIB1 is transmitted in each RMSI transmission.

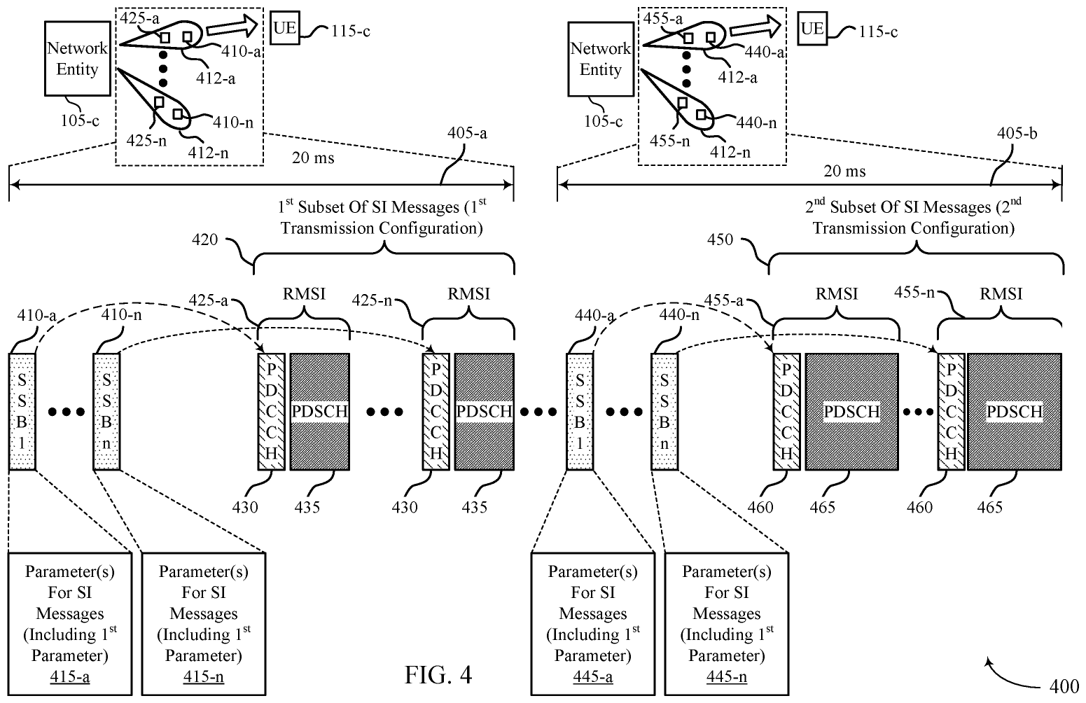

FIG. 4 illustrates an example of SSB and system information messages 400 for energy saving and overhead reduction in accordance with one or more aspects of the present disclosure. The SSB and system information messages 400 may be implemented by aspects of the wireless communications system 100, the network architecture 200, the wireless communications system 300, or some combination thereof. For example, a UE 115-c and network entity 105-c may implement the SSB and system information messages 400. As discussed herein, some instances of system information messages, such as illustrated in FIG. 4, may be transmitted using one or more transmission parameters (e.g., a higher coding rate, higher modulation order, etc.) that result in a shorter duration system information message (e.g., relative to transmissions with a lower coding rate or lower modulation order), which may reduce network power consumption, reduce overhead associated with system information messages, or any combinations thereof, and thereby enhance overall network efficiency and user experience.

In the example of FIG. 4, two RMSI cycles 405-a and 405-b are illustrated, including a first RMSI cycle 405-a and a second RMSI cycle 405-b that are each 20 ms cycles in this example. In the first RMSI cycle 405-a, a network entity 105-c may transmit, in accordance with a beam sweeping procedure, a first SSB 410-a through an nth SSB 410-n via corresponding beams 412-a through 412-n. Each of the first SSB 410-a through nth SSB 410-n may include an indication of one or more parameters for system information messages 415-a through 415-n via corresponding beams 412-a through 412-n, including a first parameter for system information messages that may be used by a UE 115-c to determine that an associated system information message (e.g., an associated RMSI) is in a first subset of system information messages 420 that use a first transmission configuration. In this example each of RMSI 425-a through RMSI 425-n in the first RMSI cycle 405-a may be included in the first subset of system information messages 420. However, in other examples, different instances of system information messages within a same RMSI cycle may be in different subsets of system information messages (e.g., different beam directions may use different MCSs for RMSI transmissions, which may be indicated by the parameters for system information messages in the corresponding SSB). Each RMSI 425-a through 425-n occasion may include an associated RMSI PDCCH 430 and RMSI PDSCH 435.

Continuing with the example of FIG. 4, during the second RMSI cycle 405-b, the network entity 105-c may transmit, in accordance with the beam sweeping procedure, a first SSB 440-a through an nth SSB 440-n via corresponding beams 412-a through 412-n, that each may include an indication of one or more parameters for system information messages 445-a through 445-n via corresponding beams 412-a through 412-n, including the first parameter for system information messages that may be used by a UE to determine that an associated system information message (e.g., an associated RMSI) is in a second subset of system information messages 450 that use a second transmission configuration. In this example each RMSI 455-a through 455-n in the second RMSI cycle 405-b may be included in the second subset of system information messages 450, which may be transmitted with a different MCS (e.g., with a lower modulation order and coding rate) than the RMSIs 425-a through 425-n of the first subset of system information messages 420. Thus, in this example, the RMSIs 455-a through 455-n of the second subset of system information messages 450 take a longer time duration to transmit than the RMSIs 425-a through 425-n of the first subset of system information messages 420. Each RMSI occasion of the second RMSI cycle 405-b also may include an associated RMSI PDCCH 460 and RMSI PDSCH 465.

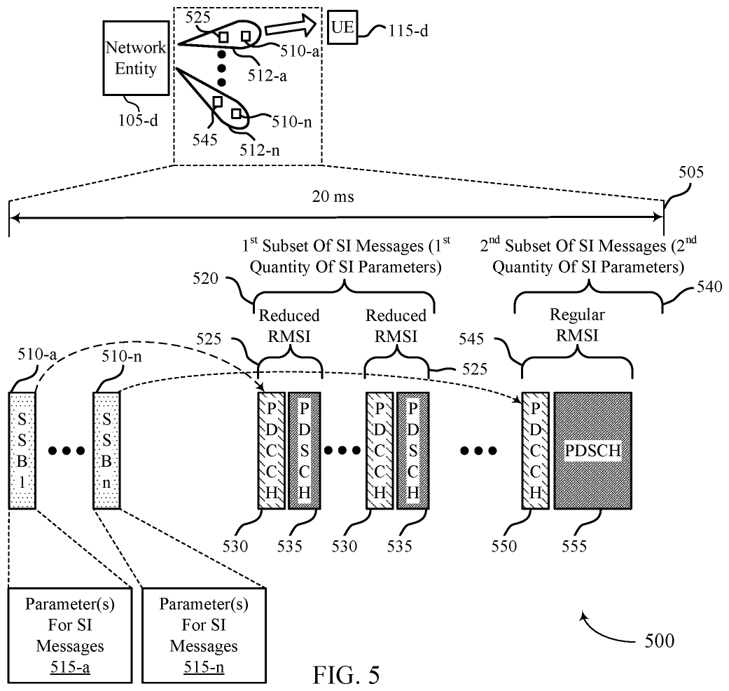

FIG. 5 illustrates another example of SSB and system information messages 500 for energy saving and overhead reduction in accordance with one or more aspects of the present disclosure. The SSB and system information messages 400 may be implemented by aspects of the wireless communications system 100, the network architecture 200, the wireless communications system 300, or some combination thereof. For example, a UE 115-d and network entity 105-d may implement the SSB and system information messages 400. As discussed herein, different instances of system information messages, such as illustrated in FIG. 5, may be transmitted with different quantities of system information parameters (e.g., transmitted with a light SIB1 or a full SIB1), that result in some system information messages having a shorter duration transmission, which may reduce network power consumption, reduce overhead associated with system information messages, or any combinations thereof, and thereby enhance overall network efficiency and user experience.

In the example of FIG. 5, a RMSI cycle 505 is illustrated, which in this example may be a 20 ms cycle. In the RMSI cycle 505, a network entity 105-d may transmit multiple SSBs 510-a through 510-n via corresponding beams 512-a through 512-n in accordance with a beam sweeping procedure, including a first SSB 510-a through an nth SSB 510-n. Each SSB 510-a through 510-n may include a corresponding indication of one or more parameters for system information messages 515-a through 515-n that may be used by a UE to determine that an associated system information message (e.g., an associated RMSI) is in a first subset of system information messages 520 that have a first quantity of system information parameters (e.g., a light SIB1), or that the associated system information message is in a second subset of system information messages 540 that have a second quantity of system information parameters (e.g., a full SIB1). In this example a first SSB 510-a may provide a first parameter for system information message 515-a that indicates reduced RMSIs 525 (e.g., with light SIB1) are provided in a first subset of system information messages 520 (e.g., via beam 512-a). For example, the reduced RMSIs 525 may include a RSMI PDCCH 530 and a RMSI PDSCH 535 that includes a light SIB1. The nth SSB 510-n in this example may provide an nth parameter for system information message 515-n that indicates a regular RMSI 545 is provided in a second subset of system information messages 540 (e.g., via beam 512-n). For example, the regular RMSI 545 may include a RSMI PDCCH 550 and a RMSI PDSCH 555 that includes a full SIB1.

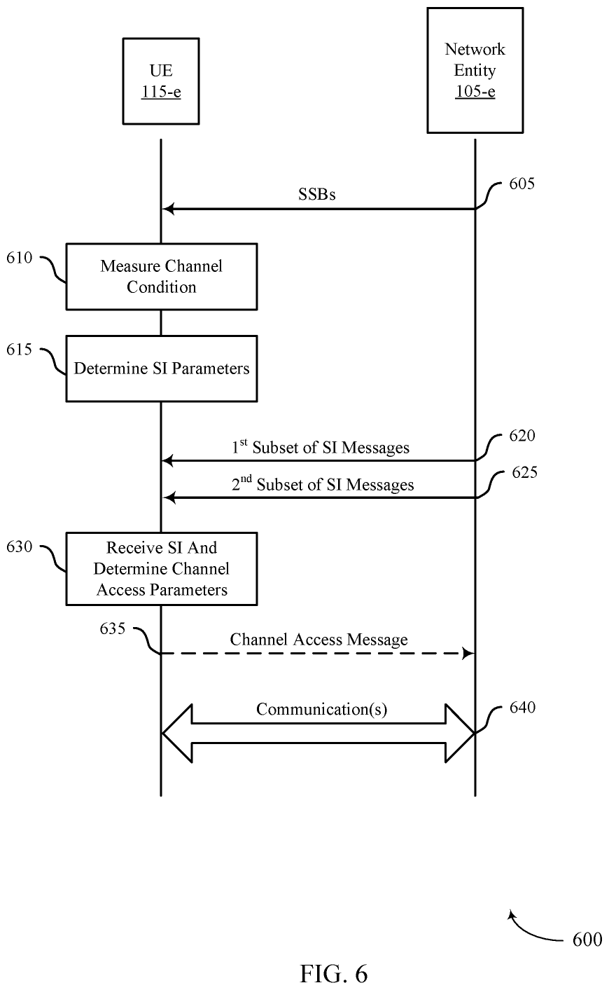

FIG. 6 illustrates an example of a process flow 600 that supports system information message techniques for energy saving and overhead reduction in accordance with one or more aspects of the present disclosure. The process flow 600 may include a network entity 105-e and a UE 115-e, which may be examples of a network entity 105 and a UE 115 as described with reference to FIGS. 1 through 5. The process flow 600 may be implemented by the network entity 105-e and the UE 115-e where different instances of system information messages may be transmitted with different transmission parameters (e.g., different MCSs), different quantities of system information parameters (e.g., transmitted with a light SIB1 or a full SIB1), or both. Such techniques may provide that some system information messages have a shorter duration transmission, which may reduce network power consumption, reduce overhead associated with system information messages, or both, and thereby enhance overall network efficiency and user experience. In the following description of the process flow 600, the operations between the network entity 105-e and the UE 115-e may be performed in a different order than the example order shown. Some operations may be omitted from the process flow 600, and other operations may be added to the process flow 600.

At 605, the network entity 105-e may transmit a series of SSBs in accordance with a beam sweeping procedure in which SSBs are transmitted in multiple different directions via multiple different beams. In some cases, the SSBs may include an indication of parameters for one or more associated system information messages, such as RMSI transmissions that are transmitted in accordance with the beam sweeping procedure in which RMSIs are transmitted in multiple different directions via multiple different beams that correspond to the SSB transmissions. In some cases, the parameters in the SSBs may indicate that the associated RMSI transmission is transmitted using an MCS associated with channel condition (e.g., RSRP) that provides reduced coverage (e.g., a RMSI transmitted with higher MCS that is reliably received in cases where the UE 115-e has a measured RSRP that is above a threshold value). In some cases, the SSB may indicate an associated threshold value that the UE 115-e may use to determine whether to attempt to decode the RMSI. In other cases, the SSB may include an indication that the corresponding RMSI has an associated high or low RSRP.

At 610, the UE 115-e may receive one of the SSBs, and measure a channel condition based on one or more signals within the SSB. For example, the UE 115-e may measure a RSRP of a synchronization signal (e.g., a primary synchronization signal or a secondary synchronization signal included in the SSB). In some cases, the SSBs may provide an indication of an associated RSRP threshold value at which the UE 115-e may be able to reliably decode the corresponding system information message (e.g., an RMSI that is transmitted using a same beam as the SSB).

At 615, the UE 115-e may determine one or more system information parameters that are associated with system information message that corresponds to the received SSB. In some cases, the system information parameters may include the associated RSRP threshold value. In some cases, the system information parameters may include an indication of a high or low RSRP, that the UE 115-e may use to determine whether to attempt to decode a system information message that corresponds to the received SSB. For example, the SSB may include an indication of a high RSRP, and the UE 115-e may compare the measured RSRP against a RSRP that would be needed to meet an average link budget for successful decoding of downlink transmission (e.g., over a prior quantity of RMSI cycles).

At 620, the network entity 105-e may transmit a first subset of the set of system information messages. The first subset of the set of system information messages may include, for example, RMSI transmissions that are transmitted using an MCS that has a relatively high coding rate or modulation order, or RMSI transmissions that include a light SIB1. At 625, the network entity 105-e may transmit a second subset of the set of system information messages. The second subset of the set of system information messages may include, for example, RMSI transmissions that are transmitted using an MCS that has a relatively low coding rate or modulation order, or RMSI transmissions that include a full SIB1.

At 630, the UE 115-e may receive the system information and determine one or more channel access parameters for communications with the network entity 105-e. In some cases, the UE 115-e may receive a system information message from the first subset of the set of system information messages based on the measured channel condition at the UE 115-e meeting an associated threshold value for system information messages of the first subset of the set of system information messages. In other cases, the UE 115-e may defer an attempt to decode a system information message from the first subset of the set of system information messages based on the measured channel condition at the UE 115-e not meeting the associated threshold value for system information messages of the first subset of the set of system information messages. In such cases, the UE 115-e may transition to a sleep mode until an instance of a system information message of the second subset of the set of system information messages.

At 635, in some examples, the UE 115-e may transmit a channel access transmission to the network entity 105-e based on the received system information. In some cases, the channel access transmission may be a RACH transmission associated with an initial channel access. In some cases, the channel access transmission may be a paging response. At 640, the UE 115-e may communicate with the network entity 105-e using based on an established connection and associated communications parameters.

FIG. 7 shows a block diagram 700 of a device 705 that supports system information transmission techniques for energy saving and overhead reduction in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to system information transmission techniques for energy saving and overhead reduction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to system information transmission techniques for energy saving and overhead reduction). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of system information transmission techniques for energy saving and overhead reduction as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The communications manager 720 may be configured as or otherwise support a means for receiving a system information message from one of the first subset of the set of system information messages or the second subset of the set of system information messages based on a channel condition at the UE and the first parameter.

Additionally, or alternatively, the communications manager 720 may support wireless communication at a UE in accordance with examples as disclosed herein. For example, the communications manager 720 may be configured as or otherwise support a means for receiving a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters. The communications manager 720 may be configured as or otherwise support a means for receiving a first system information message of the first subset of the set of system information messages. The communications manager 720 may be configured as or otherwise support a means for transmitting a first channel access transmission based on one or more system information parameters of the first quantity of system information parameters.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for system information messages that have reduced transmission times (e.g., through higher MCS, reduced system information parameters, or combinations thereof), that may provide for reduced processing overhead, reduced power consumption, and more efficient utilization of communication resources.

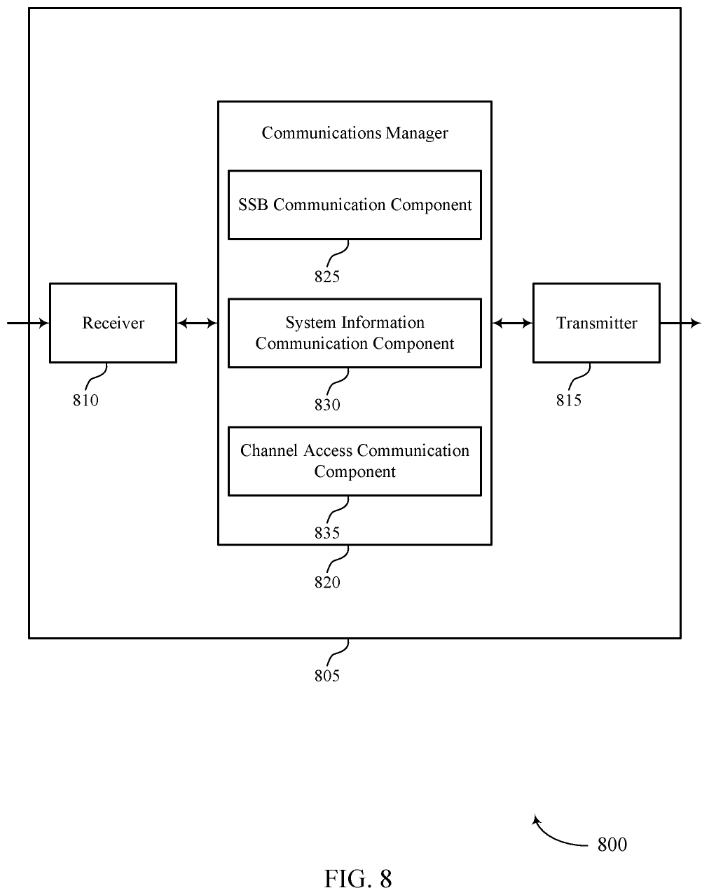

FIG. 8 shows a block diagram 800 of a device 805 that supports system information transmission techniques for energy saving and overhead reduction in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to system information transmission techniques for energy saving and overhead reduction). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to system information transmission techniques for energy saving and overhead reduction). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of system information transmission techniques for energy saving and overhead reduction as described herein. For example, the communications manager 820 may include an SSB communication component 825, a system information communication component 830, a channel access communication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The SSB communication component 825 may be configured as or otherwise support a means for receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The system information communication component 830 may be configured as or otherwise support a means for receiving a system information message from one of the first subset of the set of system information messages or the second subset of the set of system information messages based on a channel condition at the UE and the first parameter.

Additionally, or alternatively, the communications manager 820 may support wireless communication at a UE in accordance with examples as disclosed herein. The SSB communication component 825 may be configured as or otherwise support a means for receiving a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters. The system information communication component 830 may be configured as or otherwise support a means for receiving a first system information message of the first subset of the set of system information messages. The channel access communication component 835 may be configured as or otherwise support a means for transmitting a first channel access transmission based on one or more system information parameters of the first quantity of system information parameters.

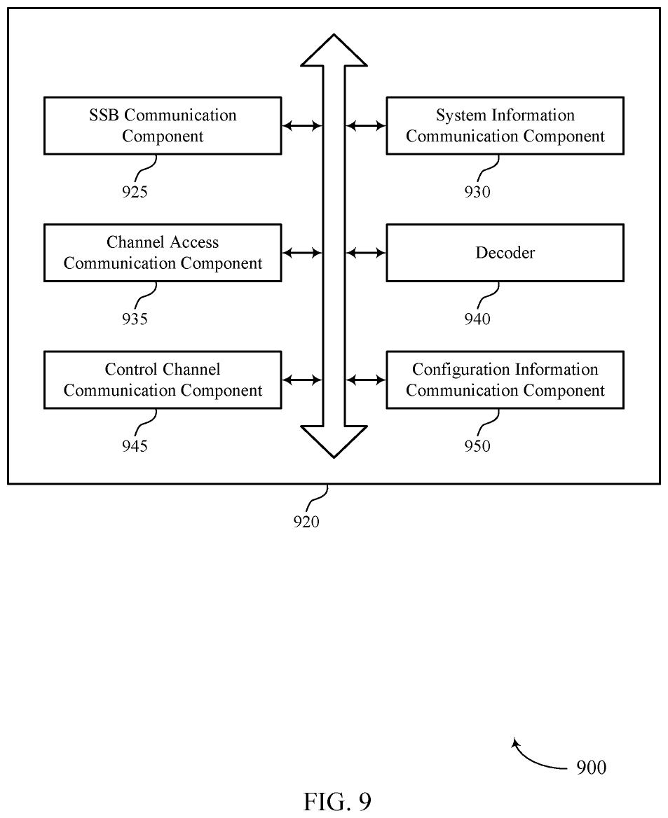

FIG. 9 shows a block diagram 900 of a communications manager 920 that supports system information transmission techniques for energy saving and overhead reduction in accordance with one or more aspects of the present disclosure. The communications manager 920 may be an example of aspects of a communications manager 720, a communications manager 820, or both, as described herein. The communications manager 920, or various components thereof, may be an example of means for performing various aspects of system information transmission techniques for energy saving and overhead reduction as described herein. For example, the communications manager 920 may include an SSB communication component 925, a system information communication component 930, a channel access communication component 935, a decoder 940, a control channel communication component 945, a configuration information communication component 950, or any combination thereof. Each of these components may communicate, directly or indirectly, with one another (e.g., via one or more buses).

The communications manager 920 may support wireless communication at a UE in accordance with examples as disclosed herein. The SSB communication component 925 may be configured as or otherwise support a means for receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The system information communication component 930 may be configured as or otherwise support a means for receiving a system information message from one of the first subset of the set of system information messages or the second subset of the set of system information messages based on a channel condition at the UE and the first parameter. In some examples, the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

In some examples, the decoder 940 may be configured as or otherwise support a means for deferring an attempt to decode a first system information message of the first subset of information transmissions based on the channel condition at the UE being below a threshold value associated with the first parameter. In some examples, the decoder 940 may be configured as or otherwise support a means for decoding a second system information message of the second subset of information transmissions based on the channel condition at the UE being below the threshold value associated with the first parameter. In some examples, the first parameter is a RSRP of a reference signal transmitted in the SSB.

In some examples, the decoder 940 may be configured as or otherwise support a means for decoding a MIB from the SSB, where the first parameter is included in the MIB. In some examples, the first parameter is a flag that indicates an associated system information message is one of the first subset of the set of system information messages or the second subset of the set of system information messages.

In some examples, the system information communication component 930 may be configured as or otherwise support a means for receiving an indication of a threshold value associated with the first parameter, and where the flag indicates that the associated system information message is to be decoded if the channel condition at the UE exceeds the threshold value. In some examples, the first parameter is received from a serving cell or from a neighbor cell, and where different values of the first parameter indicate that an associated system information message is one of the first subset of the set of system information messages or the second subset of the set of system information messages. In some examples, the first subset of the set of system information messages are transmitted in a first subset of a set of time periods, are transmitted via a first subset of a set of beams, or any combinations thereof. In some examples, the second subset of the set of system information messages are transmitted in a second subset of the set of time periods, are transmitted via a second subset of the set of beams, or any combinations thereof.

In some examples, the control channel communication component 945 may be configured as or otherwise support a means for receiving a control channel transmission associated with the system information message from one of the first subset of the set of system information messages or the second subset of the set of system information messages, where a first subset of control channel transmissions associated with the first subset of the set of system information messages have a first set of control channel parameter values, and a second subset of control channel transmissions associated with the second subset of the set of system information messages have a second set of control channel parameter values that is different from the first set of control channel parameter values.

In some examples, the set of system information messages include a first subset of the set of system information messages that each include a first quantity of system information parameters and a second subset of the set of system information messages each include a second quantity of system information parameters, and where the first quantity of system information parameters is different from the second quantity of system information parameters. In some examples, the first quantity of system information parameters is less than the second quantity of system information parameters, and provide system information for access control procedures, random access channel procedures, or any combinations thereof.

Additionally, or alternatively, the communications manager 920 may support wireless communication at a UE in accordance with examples as disclosed herein. In some examples, the SSB communication component 925 may be configured as or otherwise support a means for receiving a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters. In some examples, the system information communication component 930 may be configured as or otherwise support a means for receiving a first system information message of the first subset of the set of system information messages. The channel access communication component 935 may be configured as or otherwise support a means for transmitting a first channel access transmission based on one or more system information parameters of the first quantity of system information parameters.

In some examples, the first subset of the set of system information messages are transmitted in a first subset of a set of time periods, are transmitted via a first subset of a set of beams, or any combinations thereof. In some examples, the first quantity of system information parameters is less than the second quantity of system information parameters, and provide system information for access control procedures, random access channel procedures, or any combinations thereof. In some examples, the first subset of the set of system information messages provide an indication of a location of one or more of the second subset of the set of system information messages.

In some examples, the configuration information communication component 950 may be configured as or otherwise support a means for receiving configuration information that indicates the first subset of the set of system information messages and the second subset of the set of system information messages, the configuration information received in one or more of a MIB, a radio resource control transmission, a control information transmission, or any combinations thereof.

In some examples, the set of system information messages further include a third subset of the set of system information messages that each include a third quantity of system information parameters that is different from the first quantity of system information parameters and the second quantity of system information parameters, and where a combination of two or more of the first quantity of system information parameters, the second quantity of system information parameters, or the third quantity of system information parameters, provide a complete set of system information parameters.

In some examples, the one or more parameters include at least a first parameter that indicates a first subset of the set of system information messages have a first transmission configuration and a second subset of the set of system information messages have a second transmission configuration, and where the first system information message is received via one of the first subset of the set of system information messages or the second subset of the set of system information messages based on a channel condition at the UE and the first parameter.

In some examples, the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof. In some examples, the first parameter is a RSRP of a reference signal transmitted in the SSB. In some examples, the first subset of the set of system information messages are transmitted in a first subset of a set of time periods, are transmitted via a first subset of a set of beams, or any combinations thereof. In some examples, the second subset of the set of system information messages are transmitted in a second subset of the set of time periods, are transmitted via a second subset of the set of beams, or any combinations thereof.

In some examples, the control channel communication component 945 may be configured as or otherwise support a means for receiving a control channel transmission associated with the first system information message, where a first subset of control channel transmissions associated with the first subset of the set of system information messages have a first set of control channel parameter values, and a second subset of control channel transmissions associated with the second subset of the set of system information messages have a second set of control channel parameter values that is different from the first set of control channel parameter values.

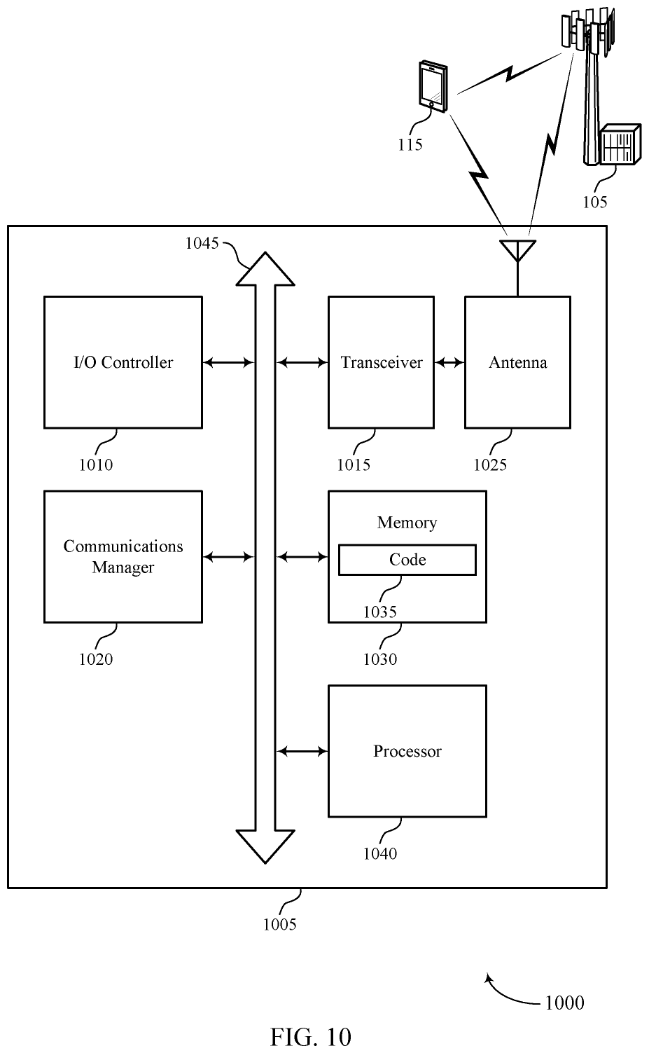

FIG. 10 shows a diagram of a system 1000 including a device 1005 that supports system information transmission techniques for energy saving and overhead reduction in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting system information transmission techniques for energy saving and overhead reduction). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The communications manager 1020 may be configured as or otherwise support a means for receiving a system information message from one of the first subset of the set of system information messages or the second subset of the set of system information messages based on a channel condition at the UE and the first parameter.

Additionally, or alternatively, the communications manager 1020 may support wireless communication at a UE in accordance with examples as disclosed herein. For example, the communications manager 1020 may be configured as or otherwise support a means for receiving a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and where the first quantity of system information parameters is different from the second quantity of system information parameters. The communications manager 1020 may be configured as or otherwise support a means for receiving a first system information message of the first subset of the set of system information messages. The communications manager 1020 may be configured as or otherwise support a means for transmitting a first channel access transmission based on one or more system information parameters of the first quantity of system information parameters.

By including or configuring the communications manager 1020 in accordance with examples as described herein, the device 1005 may support techniques for system information messages that have reduced transmission times (e.g., through higher MCS, reduced system information parameters, or combinations thereof), that may provide for reduced processing overhead, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of system information transmission techniques for energy saving and overhead reduction as described herein, or the processor 1040 and the memory 1030 may be otherwise configured to perform or support such operations.

FIG. 11 shows a block diagram 1100 of a device 1105 that supports system information transmission techniques for energy saving and overhead reduction in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of system information transmission techniques for energy saving and overhead reduction as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for outputting a SSB that indicates one or more parameters for a set of system information messages, the one or more parameters include at least a first parameter that indicates a first subset of the set of system information messages have a first transmission configuration and a second subset of the set of system information messages have a second transmission configuration. The communications manager 1120 may be configured as or otherwise support a means for outputting a first system information message of the first subset of the set of system information messages based on the first transmission configuration. The communications manager 1120 may be configured as or otherwise support a means for outputting a second system information message of the second subset of the set of system information messages based on the second transmission configuration.

Additionally, or alternatively, the communications manager 1120 may support wireless communication at a network entity in accordance with examples as disclosed herein. For example, the communications manager 1120 may be configured as or otherwise support a means for outputting a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters. The communications manager 1120 may be configured as or otherwise support a means for outputting a first system information communication for the first subset of the set of system information messages. The communications manager 1120 may be configured as or otherwise support a means for obtaining a first channel access transmission based on one or more system information parameters of the first quantity of system information parameters.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for system information messages that have reduced transmission times (e.g., through higher MCS, reduced system information parameters, or combinations thereof), that may provide for reduced processing overhead, reduced power consumption, and more efficient utilization of communication resources.

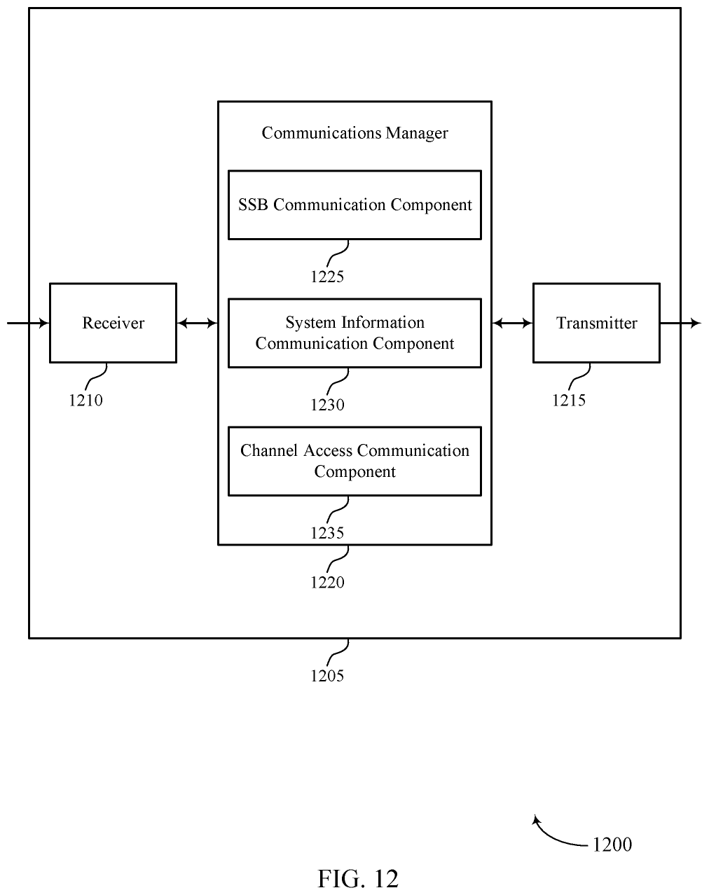

FIG. 12 shows a block diagram 1200 of a device 1205 that supports system information transmission techniques for energy saving and overhead reduction in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of system information transmission techniques for energy saving and overhead reduction as described herein. For example, the communications manager 1220 may include an SSB communication component 1225, a system information communication component 1230, a channel access communication component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The SSB communication component 1225 may be configured as or otherwise support a means for outputting a SSB that indicates one or more parameters for a set of system information messages, the one or more parameters include at least a first parameter that indicates a first subset of the set of system information messages have a first transmission configuration and a second subset of the set of system information messages have a second transmission configuration. The system information communication component 1230 may be configured as or otherwise support a means for outputting a first system information message of the first subset of the set of system information messages based on the first transmission configuration. The system information communication component 1230 may be configured as or otherwise support a means for outputting a second system information message of the second subset of the set of system information messages based on the second transmission configuration.

Additionally, or alternatively, the communications manager 1220 may support wireless communication at a network entity in accordance with examples as disclosed herein. The SSB communication component 1225 may be configured as or otherwise support a means for outputting a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters. The system information communication component 1230 may be configured as or otherwise support a means for outputting a first system information communication for the first subset of the set of system information messages. The channel access communication component 1235 may be configured as or otherwise support a means for obtaining a first channel access transmission based on one or more system information parameters of the first quantity of system information parameters.

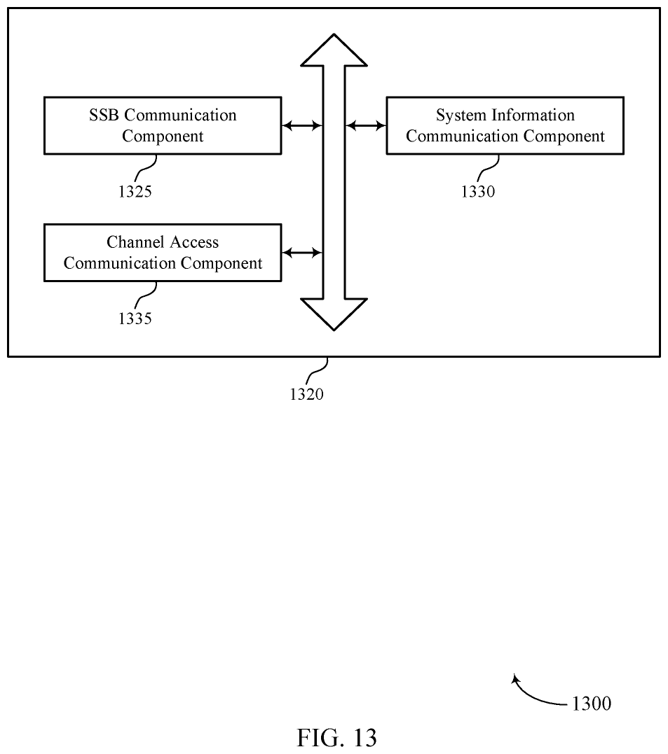

FIG. 13 shows a block diagram 1300 of a communications manager 1320 that supports system information transmission techniques for energy saving and overhead reduction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of system information transmission techniques for energy saving and overhead reduction as described herein. For example, the communications manager 1320 may include an SSB communication component 1325, a system information communication component 1330, a channel access communication component 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The SSB communication component 1325 may be configured as or otherwise support a means for outputting a SSB that indicates one or more parameters for a set of system information messages, the one or more parameters include at least a first parameter that indicates a first subset of the set of system information messages have a first transmission configuration and a second subset of the set of system information messages have a second transmission configuration. The system information communication component 1330 may be configured as or otherwise support a means for outputting a first system information message of the first subset of the set of system information messages based on the first transmission configuration. In some examples, the system information communication component 1330 may be configured as or otherwise support a means for outputting a second system information message of the second subset of the set of system information messages based on the second transmission configuration.

In some examples, the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

In some examples, the first parameter is a RSRP of a reference signal transmitted in the SSB.

Additionally, or alternatively, the communications manager 1320 may support wireless communication at a network entity in accordance with examples as disclosed herein. In some examples, the SSB communication component 1325 may be configured as or otherwise support a means for outputting a synchronization signal block that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters. In some examples, the system information communication component 1330 may be configured as or otherwise support a means for outputting a first system information communication for the first subset of the set of system information messages. The channel access communication component 1335 may be configured as or otherwise support a means for obtaining a first channel access transmission based on one or more system information parameters of the first quantity of system information parameters.

In some examples, the first subset of the set of system information messages are transmitted in a first subset of a set of time periods, are transmitted via a first subset of a set of beams, or any combinations thereof. In some examples, the first quantity of system information parameters is less than the second quantity of system information parameters, and provide system information for access control procedures, random access channel procedures, or any combinations thereof. In some examples, the first subset of the set of system information messages provide an indication of a location of one or more of the second subset of the set of system information messages.

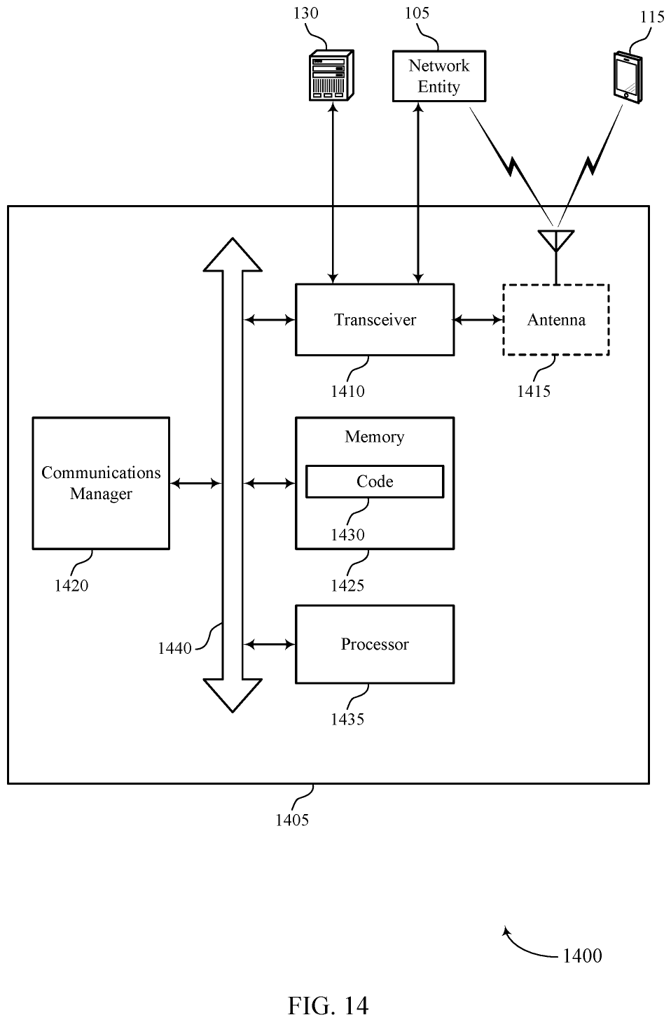

FIG. 14 shows a diagram of a system 1400 including a device 1405 that supports system information transmission techniques for energy saving and overhead reduction in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting system information transmission techniques for energy saving and overhead reduction). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1405 may transmit information output from the chip or modem. In some implementations, the second interface may refer to an interface between the processing system of the chip or modem and a receiver, such that the device 1405 may obtain information or signal inputs, and the information may be passed to the processing system. A person having ordinary skill in the art will readily recognize that the first interface also may obtain information or signal inputs, and the second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for outputting a SSB that indicates one or more parameters for a set of system information messages, the one or more parameters include at least a first parameter that indicates a first subset of the set of system information messages have a first transmission configuration and a second subset of the set of system information messages have a second transmission configuration. The communications manager 1420 may be configured as or otherwise support a means for outputting a first system information message of the first subset of the set of system information messages based on the first transmission configuration. The communications manager 1420 may be configured as or otherwise support a means for outputting a second system information message of the second subset of the set of system information messages based on the second transmission configuration.

Additionally, or alternatively, the communications manager 1420 may support wireless communication at a network entity in accordance with examples as disclosed herein. For example, the communications manager 1420 may be configured as or otherwise support a means for outputting a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters. The communications manager 1420 may be configured as or otherwise support a means for outputting a first system information communication for the first subset of the set of system information messages. The communications manager 1420 may be configured as or otherwise support a means for obtaining a first channel access transmission based on one or more system information parameters of the first quantity of system information parameters.

By including or configuring the communications manager 1420 in accordance with examples as described herein, the device 1405 may support techniques for system information messages that have reduced transmission times (e.g., through higher MCS, reduced system information parameters, or combinations thereof), that may provide for reduced processing overhead, reduced power consumption, and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of system information transmission techniques for energy saving and overhead reduction as described herein, or the processor 1435 and the memory 1425 may be otherwise configured to perform or support such operations.

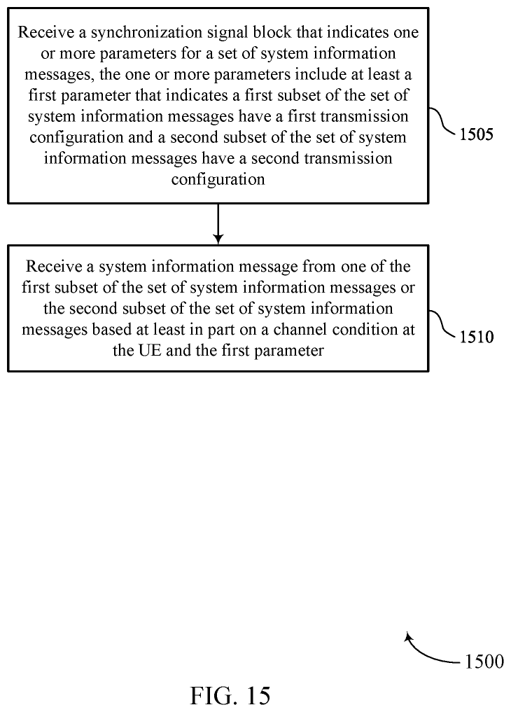

FIG. 15 shows a flowchart illustrating a method 1500 that supports system information transmission techniques for energy saving and overhead reduction in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The operations of 1505 may be performed in accordance with examples as disclosed herein. In some examples, aspects of the operations of 1505 may be performed by an SSB communication component 925 as described with reference to FIG. 9.

At 1510, the method may include receiving a system information message from one of the first subset of the set of system information messages or the second subset of the set of system information messages based on a channel condition at the UE and the first parameter. The operations of 1510 may be performed in accordance with examples as disclosed herein. In some examples, aspects of the operations of 1510 may be performed by a system information communication component 930 as described with reference to FIG. 9.

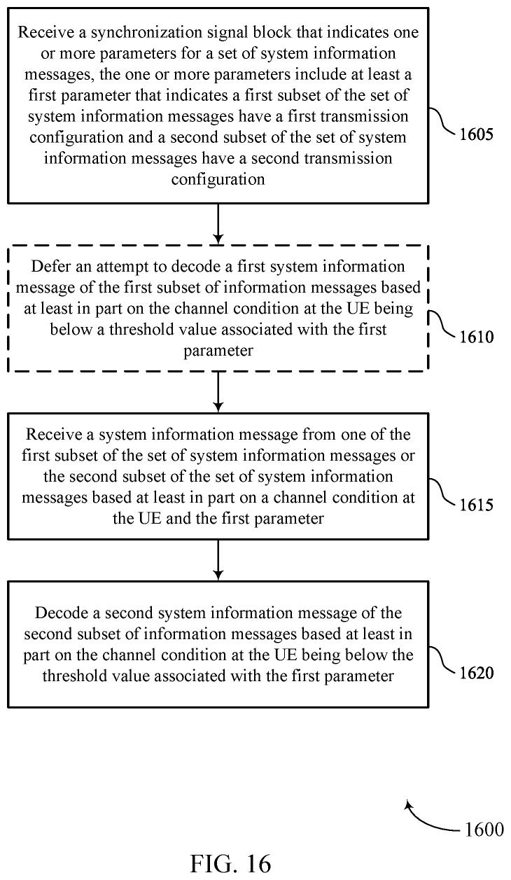

FIG. 16 shows a flowchart illustrating a method 1600 that supports system information transmission techniques for energy saving and overhead reduction in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The operations of 1605 may be performed in accordance with examples as disclosed herein. In some examples, aspects of the operations of 1605 may be performed by an SSB communication component 925 as described with reference to FIG. 9.

Optionally, at 1610, the method may include deferring an attempt to decode a first system information message of the first subset of information transmissions based on the channel condition at the UE being below a threshold value associated with the first parameter. The operations of 1610 may be performed in accordance with examples as disclosed herein. In some examples, aspects of the operations of 1610 may be performed by a decoder 940 as described with reference to FIG. 9.

At 1615, the method may include receiving a system information message from one of the first subset of the set of system information messages or the second subset of the set of system information messages based on a channel condition at the UE and the first parameter. The operations of 1615 may be performed in accordance with examples as disclosed herein. In some examples, aspects of the operations of 1615 may be performed by a system information communication component 930 as described with reference to FIG. 9.

At 1620, the method may include decoding a second system information message of the second subset of information transmissions based on the channel condition at the UE being below the threshold value associated with the first parameter. The operations of 1620 may be performed in accordance with examples as disclosed herein. In some examples, aspects of the operations of 1620 may be performed by a decoder 940 as described with reference to FIG. 9.

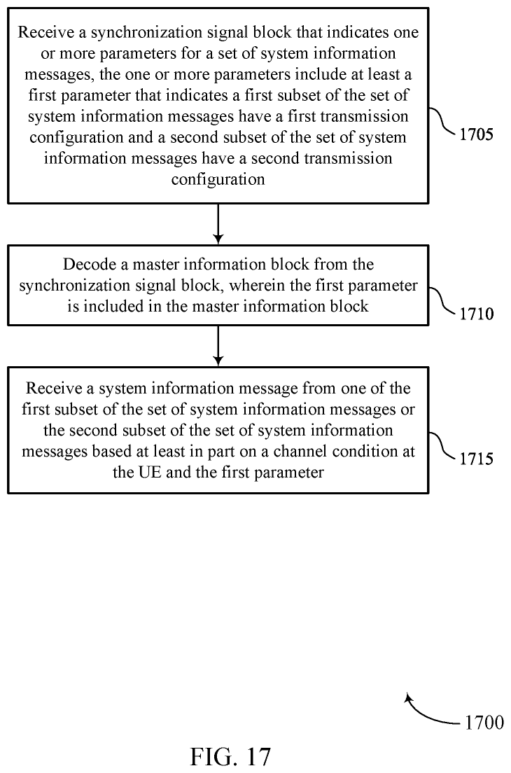

FIG. 17 shows a flowchart illustrating a method 1700 that supports system information transmission techniques for energy saving and overhead reduction in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The operations of 1705 may be performed in accordance with examples as disclosed herein. In some examples, aspects of the operations of 1705 may be performed by an SSB communication component 925 as described with reference to FIG. 9.

At 1710, the method may include decoding a MIB from the SSB, where the first parameter is included in the MIB. The operations of 1710 may be performed in accordance with examples as disclosed herein. In some examples, aspects of the operations of 1710 may be performed by a decoder 940 as described with reference to FIG. 9.

At 1715, the method may include receiving a system information message from one of the first subset of the set of system information messages or the second subset of the set of system information messages based on a channel condition at the UE and the first parameter. The operations of 1715 may be performed in accordance with examples as disclosed herein. In some examples, aspects of the operations of 1715 may be performed by a system information communication component 930 as described with reference to FIG. 9.

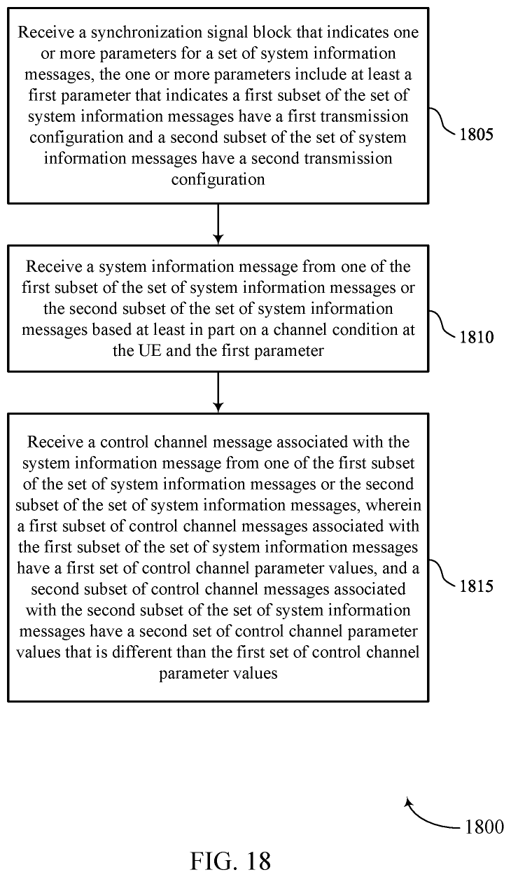

FIG. 18 shows a flowchart illustrating a method 1800 that supports system information transmission techniques for energy saving and overhead reduction in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a SSB that indicates one or more parameters for a set of system information messages, the one or more parameters include at least a first parameter that indicates a first subset of the set of system information messages have a first transmission configuration and a second subset of the set of system information messages have a second transmission configuration. The operations of 1805 may be performed in accordance with examples as disclosed herein. In some examples, aspects of the operations of 1805 may be performed by an SSB communication component 925 as described with reference to FIG. 9.

At 1810, the method may include receiving a system information message from one of the first subset of the set of system information messages or the second subset of the set of system information messages based on a channel condition at the UE and the first parameter. The operations of 1810 may be performed in accordance with examples as disclosed herein. In some examples, aspects of the operations of 1810 may be performed by a system information communication component 930 as described with reference to FIG. 9.

At 1815, the method may include receiving a control channel transmission associated with the system information message from one of the first subset of the set of system information messages or the second subset of the set of system information messages, where a first subset of control channel transmissions associated with the first subset of the set of system information messages have a first set of control channel parameter values, and a second subset of control channel transmissions associated with the second subset of the set of system information messages have a second set of control channel parameter values that is different from the first set of control channel parameter values. The operations of 1815 may be performed in accordance with examples as disclosed herein. In some examples, aspects of the operations of 1815 may be performed by a control channel communication component 945 as described with reference to FIG. 9.

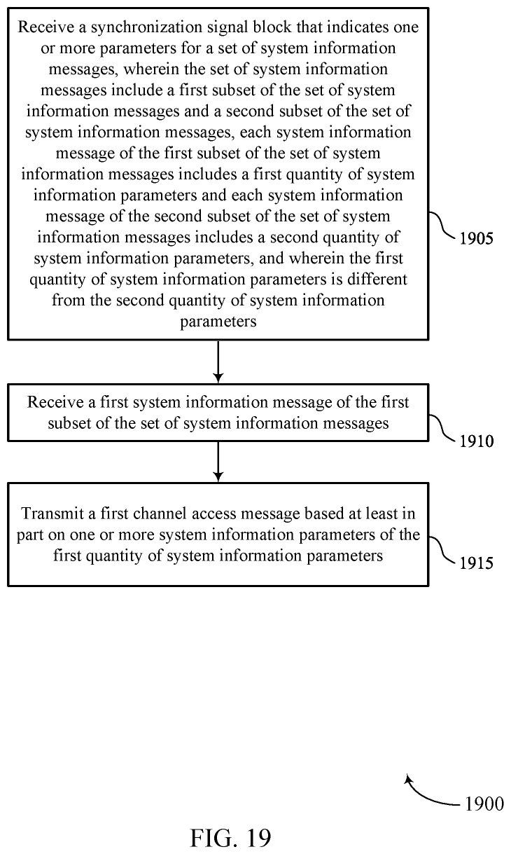

FIG. 19 shows a flowchart illustrating a method 1900 that supports system information transmission techniques for energy saving and overhead reduction in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving a SSB that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters. The operations of 1905 may be performed in accordance with examples as disclosed herein. In some examples, aspects of the operations of 1905 may be performed by an SSB communication component 925 as described with reference to FIG. 9.

At 1910, the method may include receiving a first system information message of the first subset of the set of system information messages. The operations of 1910 may be performed in accordance with examples as disclosed herein. In some examples, aspects of the operations of 1910 may be performed by a system information communication component 930 as described with reference to FIG. 9.

At 1915, the method may include transmitting a first channel access transmission based on one or more system information parameters of the first quantity of system information parameters. The operations of 1915 may be performed in accordance with examples as disclosed herein. In some examples, aspects of the operations of 1915 may be performed by a channel access communication component 935 as described with reference to FIG. 9.

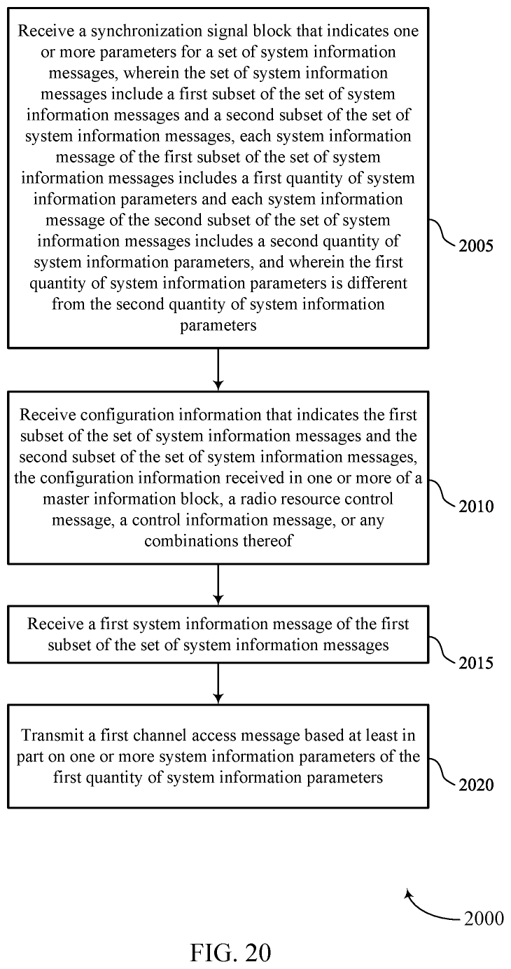

FIG. 20 shows a flowchart illustrating a method 2000 that supports system information transmission techniques for energy saving and overhead reduction in accordance with one or more aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include receiving a SSB that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters. The operations of 2005 may be performed in accordance with examples as disclosed herein. In some examples, aspects of the operations of 2005 may be performed by an SSB communication component 925 as described with reference to FIG. 9.

At 2010, the method may include receiving configuration information that indicates the first subset of the set of system information messages and the second subset of the set of system information messages, the configuration information received in one or more of a MIB, a radio resource control transmission, a control information transmission, or any combinations thereof. The operations of 2010 may be performed in accordance with examples as disclosed herein. In some examples, aspects of the operations of 2010 may be performed by a configuration information communication component 950 as described with reference to FIG. 9.

At 2015, the method may include receiving a first system information message of the first subset of the set of system information messages. The operations of 2015 may be performed in accordance with examples as disclosed herein. In some examples, aspects of the operations of 2015 may be performed by a system information communication component 930 as described with reference to FIG. 9.

At 2020, the method may include transmitting a first channel access transmission based on one or more system information parameters of the first quantity of system information parameters. The operations of 2020 may be performed in accordance with examples as disclosed herein. In some examples, aspects of the operations of 2020 may be performed by a channel access communication component 935 as described with reference to FIG. 9.

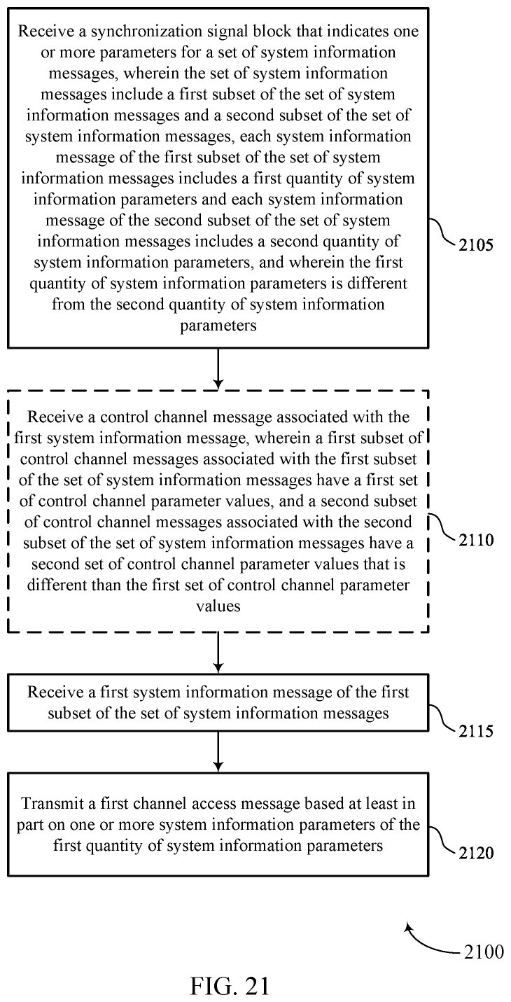

FIG. 21 shows a flowchart illustrating a method 2100 that supports system information transmission techniques for energy saving and overhead reduction in accordance with one or more aspects of the present disclosure. The operations of the method 2100 may be implemented by a UE or its components as described herein. For example, the operations of the method 2100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2105, the method may include receiving a SSB that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters. The operations of 2105 may be performed in accordance with examples as disclosed herein. In some examples, aspects of the operations of 2105 may be performed by an SSB communication component 925 as described with reference to FIG. 9.

Optionally, at 2110, the method may include receiving a control channel transmission associated with the first system information message, where a first subset of control channel transmissions associated with the first subset of the set of system information messages have a first set of control channel parameter values, and a second subset of control channel transmissions associated with the second subset of the set of system information messages have a second set of control channel parameter values that is different from the first set of control channel parameter values. The operations of 2110 may be performed in accordance with examples as disclosed herein. In some examples, aspects of the operations of 2110 may be performed by a control channel communication component 945 as described with reference to FIG. 9.

At 2115, the method may include receiving a first system information message of the first subset of the set of system information messages. The operations of 2115 may be performed in accordance with examples as disclosed herein. In some examples, aspects of the operations of 2115 may be performed by a system information communication component 930 as described with reference to FIG. 9.

At 2120, the method may include transmitting a first channel access transmission based on one or more system information parameters of the first quantity of system information parameters. The operations of 2120 may be performed in accordance with examples as disclosed herein. In some examples, aspects of the operations of 2120 may be performed by a channel access communication component 935 as described with reference to FIG. 9.

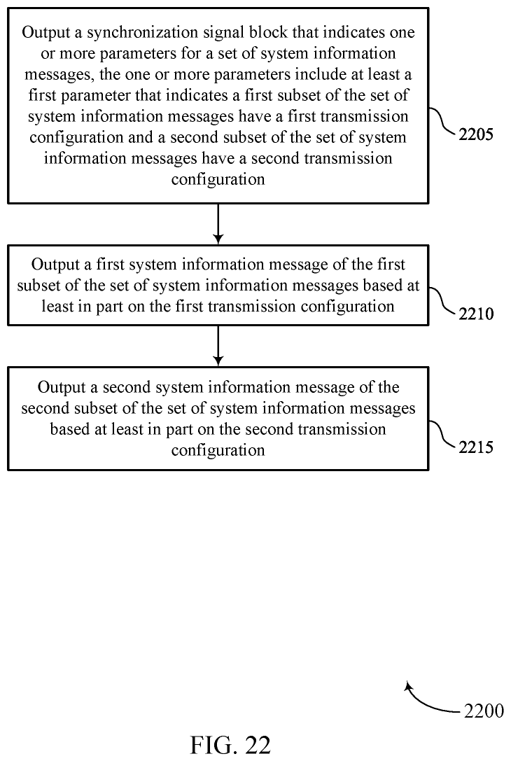

FIG. 22 shows a flowchart illustrating a method 2200 that supports system information transmission techniques for energy saving and overhead reduction in accordance with one or more aspects of the present disclosure. The operations of the method 2200 may be implemented by a network entity or its components as described herein. For example, the operations of the method 2200 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2205, the method may include outputting a SSB that indicates one or more parameters for a set of system information messages, the one or more parameters include at least a first parameter that indicates a first subset of the set of system information messages have a first transmission configuration and a second subset of the set of system information messages have a second transmission configuration. The operations of 2205 may be performed in accordance with examples as disclosed herein. In some examples, aspects of the operations of 2205 may be performed by an SSB communication component 1325 as described with reference to FIG. 13.

At 2210, the method may include outputting a first system information message of the first subset of the set of system information messages based on the first transmission configuration. The operations of 2210 may be performed in accordance with examples as disclosed herein. In some examples, aspects of the operations of 2210 may be performed by a system information communication component 1330 as described with reference to FIG. 13.

At 2215, the method may include outputting a second system information message of the second subset of the set of system information messages based on the second transmission configuration. The operations of 2215 may be performed in accordance with examples as disclosed herein. In some examples, aspects of the operations of 2215 may be performed by a system information communication component 1330 as described with reference to FIG. 13.

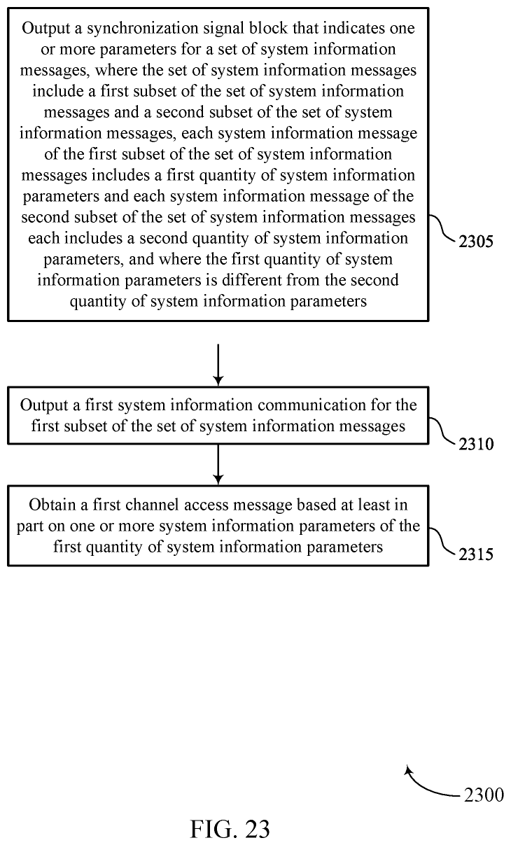

FIG. 23 shows a flowchart illustrating a method 2300 that supports system information transmission techniques for energy saving and overhead reduction in accordance with one or more aspects of the present disclosure. The operations of the method 2300 may be implemented by a network entity or its components as described herein. For example, the operations of the method 2300 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2305, the method may include outputting a SSB that indicates one or more parameters for a set of system information messages, where the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and where the first quantity of system information parameters is different from the second quantity of system information parameters. The operations of 2305 may be performed in accordance with examples as disclosed herein. In some examples, aspects of the operations of 2305 may be performed by an SSB communication component 1325 as described with reference to FIG. 13.

At 2310, the method may include outputting a first system information communication for the first subset of the set of system information messages. The operations of 2310 may be performed in accordance with examples as disclosed herein. In some examples, aspects of the operations of 2310 may be performed by a system information communication component 1330 as described with reference to FIG. 13.

At 2315, the method may include obtaining a first channel access transmission based on one or more system information parameters of the first quantity of system information parameters. The operations of 2315 may be performed in accordance with examples as disclosed herein. In some examples, aspects of the operations of 2315 may be performed by a channel access communication component 1335 as described with reference to FIG. 13.

The following provides an overview of aspects of the present disclosure:

Aspect 1: A method for wireless communication at a UE, comprising: receiving a synchronization signal block that indicates one or more parameters for a set of system information messages, the one or more parameters include at least a first parameter that indicates a first subset of the set of system information messages have a first transmission configuration and a second subset of the set of system information messages have a second transmission configuration; and receiving a system information message from one of the first subset of the set of system information messages or the second subset of the set of system information messages based at least in part on a channel condition at the UE and the first parameter.

Aspect 2: The method of aspect 1, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 3: The method of any of aspects 1 through 2, wherein the receiving the system information message comprises: deferring an attempt to decode a first system information message of the first subset of information transmissions based at least in part on the channel condition at the UE being below a threshold value associated with the first parameter; and decoding a second system information message of the second subset of information transmissions based at least in part on the channel condition at the UE being below the threshold value associated with the first parameter.

Aspect 4: The method of aspect 3, wherein the first parameter is a reference signal received power of a reference signal transmitted in the synchronization signal block.

Aspect 5: The method of any of aspects 1 through 4, wherein the receiving a synchronization signal block comprises: decoding a master information block from the synchronization signal block, wherein the first parameter is included in the master information block.

Aspect 6: The method of aspect 5, wherein the first parameter is a flag that indicates an associated system information message is one of the first subset of the set of system information messages or the second subset of the set of system information messages.

Aspect 7: The method of aspect 6, further comprising: receiving an indication of a threshold value associated with the first parameter, and wherein the flag indicates that the associated system information message is to be decoded if the channel condition at the UE exceeds the threshold value.

Aspect 8: The method of any of aspects 1 through 7, wherein the first parameter is received from a serving cell or from a neighbor cell, and wherein different values of the first parameter indicate that an associated system information message is one of the first subset of the set of system information messages or the second subset of the set of system information messages.

Aspect 9: The method of any of aspects 1 through 8, wherein the first subset of the set of system information messages are transmitted in a first subset of a set of time periods, are transmitted via a first subset of a set of beams, or any combinations thereof, and the second subset of the set of system information messages are transmitted in a second subset of the set of time periods, are transmitted via a second subset of the set of beams, or any combinations thereof.

Aspect 10: The method of any of aspects 1 through 9, further comprising: receiving a control channel transmission associated with the system information message from one of the first subset of the set of system information messages or the second subset of the set of system information messages, wherein a first subset of control channel transmissions associated with the first subset of the set of system information messages have a first set of control channel parameter values, and a second subset of control channel transmissions associated with the second subset of the set of system information messages have a second set of control channel parameter values that is different than the first set of control channel parameter values.

Aspect 11: The method of any of aspects 1 through 10, wherein the set of system information messages include a first subset of the set of system information messages that each include a first quantity of system information parameters and a second subset of the set of system information messages each include a second quantity of system information parameters, and wherein the first quantity of system information parameters is different than the second quantity of system information parameters.

Aspect 12: The method of aspect 11, wherein the first quantity of system information parameters is less than the second quantity of system information parameters, and provide system information for access control procedures, random access channel procedures, or any combinations thereof.

Aspect 13: A method for wireless communication at a UE, comprising: receiving a synchronization signal block that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters; receiving a first system information message of the first subset of the set of system information messages; and transmitting a first channel access transmission based at least in part on one or more system information parameters of the first quantity of system information parameters.

Aspect 14: The method of aspect 13, wherein the first subset of the set of system information messages are transmitted in a first subset of a set of time periods, are transmitted via a first subset of a set of beams, or any combinations thereof.

Aspect 15: The method of any of aspects 13 through 14, wherein the first quantity of system information parameters is less than the second quantity of system information parameters, and provide system information for access control procedures, random access channel procedures, or any combinations thereof.

Aspect 16: The method of any of aspects 13 through 15, wherein the first subset of the set of system information messages provide an indication of a location of one or more of the second subset of the set of system information messages.

Aspect 17: The method of any of aspects 13 through 16, further comprising: receiving configuration information that indicates the first subset of the set of system information messages and the second subset of the set of system information messages, the configuration information received in one or more of a master information block, a radio resource control transmission, a control information transmission, or any combinations thereof.

Aspect 18: The method of any of aspects 13 through 17, wherein the set of system information messages further include a third subset of the set of system information messages that each include a third quantity of system information parameters that is different than the first quantity of system information parameters and the second quantity of system information parameters, and wherein a combination of two or more of the first quantity of system information parameters, the second quantity of system information parameters, or the third quantity of system information parameters, provide a complete set of system information parameters.

Aspect 19: The method of any of aspects 13 through 18, wherein the one or more parameters include at least a first parameter that indicates a first subset of the set of system information messages have a first transmission configuration and a second subset of the set of system information messages have a second transmission configuration, and wherein the first system information message is received via one of the first subset of the set of system information messages or the second subset of the set of system information messages based at least in part on a channel condition at the UE and the first parameter.

Aspect 20: The method of aspect 19, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 21: The method of any of aspects 19 through 20, wherein the first parameter is a reference signal received power of a reference signal transmitted in the synchronization signal block.

Aspect 22: The method of any of aspects 13 through 21, wherein the first subset of the set of system information messages are transmitted in a first subset of a set of time periods, are transmitted via a first subset of a set of beams, or any combinations thereof, and the second subset of the set of system information messages are transmitted in a second subset of the set of time periods, are transmitted via a second subset of the set of beams, or any combinations thereof.

Aspect 23: The method of any of aspects 13 through 22, further comprising: receiving a control channel transmission associated with the first system information message, wherein a first subset of control channel transmissions associated with the first subset of the set of system information messages have a first set of control channel parameter values, and a second subset of control channel transmissions associated with the second subset of the set of system information messages have a second set of control channel parameter values that is different than the first set of control channel parameter values.

Aspect 24: A method for wireless communication at a network entity, comprising: outputting a synchronization signal block that indicates one or more parameters for a set of system information messages, the one or more parameters include at least a first parameter that indicates a first subset of the set of system information messages have a first transmission configuration and a second subset of the set of system information messages have a second transmission configuration; outputting a first system information message of the first subset of the set of system information messages based at least in part on the first transmission configuration; and outputting a second system information message of the second subset of the set of system information messages based at least in part on the second transmission configuration.

Aspect 25: The method of aspect 24, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 26: The method of any of aspects 24 through 25, wherein the first parameter is a reference signal received power of a reference signal transmitted in the synchronization signal block.

Aspect 27: A method for wireless communication at a network entity, comprising: outputting a synchronization signal block that indicates one or more parameters for a set of system information messages, wherein the set of system information messages include a first subset of the set of system information messages that each include a first quantity of system information parameters and a second subset of the set of system information messages each include a second quantity of system information parameters, and wherein the first quantity of system information parameters is different than the second quantity of system information parameters; outputting a first system information communication for the first subset of the set of system information messages; and obtaining a first channel access transmission based at least in part on one or more system information parameters of the first quantity of system information parameters.

Aspect 28: The method of aspect 27, wherein the first subset of the set of system information messages are transmitted in a first subset of a set of time periods, are transmitted via a first subset of a set of beams, or any combinations thereof.

Aspect 29: The method of any of aspects 27 through 28, wherein the first quantity of system information parameters is less than the second quantity of system information parameters, and provide system information for access control procedures, random access channel procedures, or any combinations thereof.

Aspect 30: The method of any of aspects 27 through 29, wherein the first subset of the set of system information messages provide an indication of a location of one or more of the second subset of the set of system information messages.

Aspect 31: An apparatus for wireless communication at a UE, comprising: a processor; and memory coupled with the processor, the processor configured to: receive a synchronization signal block that indicates one or more parameters for a set of system information messages, the one or more parameters include at least a first parameter that indicates a first subset of the set of system information messages have a first transmission configuration and a second subset of the set of system information messages have a second transmission configuration; and receive a system information message from one of the first subset of the set of system information messages or the second subset of the set of system information messages based at least in part on a channel condition at the UE and the first parameter.

Aspect 32: The apparatus of aspect 31, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 33: The apparatus of any of aspects 31 through 32, wherein, to receive the system information message, the processor is configured to: defer an attempt to decode a first system information message of the first subset of information transmissions based at least in part on the channel condition at the UE being below a threshold value associated with the first parameter; and decode a second system information message of the second subset of information transmissions based at least in part on the channel condition at the UE being below the threshold value associated with the first parameter.

Aspect 34: The apparatus of aspect 33, wherein the first parameter is a reference signal received power of a reference signal transmitted in the synchronization signal block.

Aspect 35: The apparatus of any of aspects 31 through 34, wherein, to receive the synchronization signal block, the processor is configured to: decode a master information block from the synchronization signal block, wherein the first parameter is included in the master information block.

Aspect 36: The apparatus of aspect 35, wherein the first parameter is a flag that indicates an associated system information message is one of the first subset of the set of system information messages or the second subset of the set of system information messages.

Aspect 37: The apparatus of aspect 36, wherein the processor is further configured to: receive an indication of a threshold value associated with the first parameter, and wherein the flag indicates that the associated system information message is to be decoded if the channel condition at the UE exceeds the threshold value.

Aspect 38: The apparatus of any of aspects 31 through 37, wherein the first parameter is received from a serving cell or from a neighbor cell, and wherein different values of the first parameter indicate that an associated system information message is one of the first subset of the set of system information messages or the second subset of the set of system information messages.

Aspect 39: The apparatus of any of aspects 31 through 38, wherein the first subset of the set of system information messages are transmitted in a first subset of a set of time periods, are transmitted via a first subset of a set of beams, or any combinations thereof, and the second subset of the set of system information messages are transmitted in a second subset of the set of time periods, are transmitted via a second subset of the set of beams, or any combinations thereof.

Aspect 40: The apparatus of any of aspects 31 through 39, wherein the processor is further configured to: receive a control channel transmission associated with the system information message from one of the first subset of the set of system information messages or the second subset of the set of system information messages, wherein a first subset of control channel transmissions associated with the first subset of the set of system information messages have a first set of control channel parameter values, and a second subset of control channel transmissions associated with the second subset of the set of system information messages have a second set of control channel parameter values that is different than the first set of control channel parameter values.

Aspect 41: The apparatus of any of aspects 31 through 40, wherein the set of system information messages include a first subset of the set of system information messages that each include a first quantity of system information parameters and a second subset of the set of system information messages each include a second quantity of system information parameters, and wherein the first quantity of system information parameters is different than the second quantity of system information parameters.

Aspect 42: The apparatus of aspect 41, wherein the first quantity of system information parameters is less than the second quantity of system information parameters, and provide system information for access control procedures, random access channel procedures, or any combinations thereof.

Aspect 43: An apparatus for wireless communication at a UE, comprising: a processor; and memory coupled with the processor, the processor configured to: receive a synchronization signal block that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters; receiving a first system information message of the first subset of the set of system information messages; and transmit a first channel access transmission based at least in part on one or more system information parameters of the first quantity of system information parameters.

Aspect 44: The apparatus of aspect 43, wherein the first subset of the set of system information messages are transmitted in a first subset of a set of time periods, are transmitted via a first subset of a set of beams, or any combinations thereof.

Aspect 45: The apparatus of any of aspects 43 through 44, wherein the first quantity of system information parameters is less than the second quantity of system information parameters, and provide system information for access control procedures, random access channel procedures, or any combinations thereof.

Aspect 46: The apparatus of any of aspects 43 through 45, wherein the first subset of the set of system information messages provide an indication of a location of one or more of the second subset of the set of system information messages.

Aspect 47: The apparatus of any of aspects 43 through 46, wherein the processor is further configured to: receive configuration information that indicates the first subset of the set of system information messages and the second subset of the set of system information messages, the configuration information received in one or more of a master information block, a radio resource control transmission, a control information transmission, or any combinations thereof.

Aspect 48: The apparatus of any of aspects 43 through 47, wherein the set of system information messages further include a third subset of the set of system information messages that each include a third quantity of system information parameters that is different than the first quantity of system information parameters and the second quantity of system information parameters, and wherein a combination of two or more of the first quantity of system information parameters, the second quantity of system information parameters, or the third quantity of system information parameters, provide a complete set of system information parameters.

Aspect 49: The apparatus of any of aspects 43 through 48, wherein the one or more parameters include at least a first parameter that indicates a first subset of the set of system information messages have a first transmission configuration and a second subset of the set of system information messages have a second transmission configuration, and wherein the first system information message is received via one of the first subset of the set of system information messages or the second subset of the set of system information messages based at least in part on a channel condition at the UE and the first parameter.

Aspect 50: The apparatus of aspect 49, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 51: The apparatus of any of aspects 49 through 50, wherein the first parameter is a reference signal received power of a reference signal transmitted in the synchronization signal block.

Aspect 52: The apparatus of any of aspects 43 through 51, wherein the first subset of the set of system information messages are transmitted in a first subset of a set of time periods, are transmitted via a first subset of a set of beams, or any combinations thereof, and the second subset of the set of system information messages are transmitted in a second subset of the set of time periods, are transmitted via a second subset of the set of beams, or any combinations thereof.

Aspect 53: The apparatus of any of aspects 43 through 52, wherein the processor is further configured to: receive a control channel transmission associated with the first system information message, wherein a first subset of control channel transmissions associated with the first subset of the set of system information messages have a first set of control channel parameter values, and a second subset of control channel transmissions associated with the second subset of the set of system information messages have a second set of control channel parameter values that is different than the first set of control channel parameter values.

Aspect 54: An apparatus for wireless communication at a network entity, comprising: a processor; and memory coupled with the processor, the processor configured to: output a synchronization signal block that indicates one or more parameters for a set of system information messages, the one or more parameters include at least a first parameter that indicates a first subset of the set of system information messages have a first transmission configuration and a second subset of the set of system information messages have a second transmission configuration; output a first system information message of the first subset of the set of system information messages based at least in part on the first transmission configuration; and output a second system information message of the second subset of the set of system information messages based at least in part on the second transmission configuration.

Aspect 55: The apparatus of aspect 54, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

Aspect 56: The apparatus of any of aspects 54 through 55, wherein the first parameter is a reference signal received power of a reference signal transmitted in the synchronization signal block.

Aspect 57: An apparatus for wireless communication at a network entity, comprising: a processor; and memory coupled with the processor, the processor configured to: output a synchronization signal block that indicates one or more parameters for a set of system information messages, wherein the set of system information messages include a first subset of the set of system information messages that each include a first quantity of system information parameters and a second subset of the set of system information messages each include a second quantity of system information parameters, and wherein the first quantity of system information parameters is different than the second quantity of system information parameters; output a first system information communication for the first subset of the set of system information messages; and obtain a first channel access transmission based at least in part on one or more system information parameters of the first quantity of system information parameters.

Aspect 58: The apparatus of aspect 57, wherein the first subset of the set of system information messages are transmitted in a first subset of a set of time periods, are transmitted via a first subset of a set of beams, or any combinations thereof.

Aspect 59: The apparatus of any of aspects 57 through 58, wherein the first quantity of system information parameters is less than the second quantity of system information parameters, and provide system information for access control procedures, random access channel procedures, or any combinations thereof.

Aspect 60: The apparatus of any of aspects 57 through 59, wherein the first subset of the set of system information messages provide an indication of a location of one or more of the second subset of the set of system information messages.

Aspect 61: An apparatus for wireless communication at a UE, comprising at least one means for performing a method of any of aspects 1 through 12.

Aspect 62: A non-transitory computer-readable medium storing code for wireless communication at a UE, the code comprising instructions executable by a processor to perform a method of any of aspects 1 through 12.

Aspect 63: An apparatus for wireless communication at a UE, comprising at least one means for performing a method of any of aspects 13 through 23.

Aspect 64: A non-transitory computer-readable medium storing code for wireless communication at a UE, the code comprising instructions executable by a processor to perform a method of any of aspects 13 through 23.

Aspect 65: An apparatus for wireless communication at a network entity, comprising at least one means for performing a method of any of aspects 24 through 26.

Aspect 66: A non-transitory computer-readable medium storing code for wireless communication at a network entity, the code comprising instructions executable by a processor to perform a method of any of aspects 24 through 26.

Aspect 67: An apparatus for wireless communication at a network entity, comprising at least one means for performing a method of any of aspects 27 through 30.

Aspect 68: A non-transitory computer-readable medium storing code for wireless communication at a network entity, the code comprising instructions executable by a processor to perform a method of any of aspects 27 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
receive a synchronization signal block that indicates one or more parameters for a set of system information messages, the one or more parameters include at least a first parameter that indicates a first subset of the set of system information messages have a first message configuration and a second subset of the set of system information messages have a second message configuration; and
receive a system information message from one of the first subset of the set of system information messages or the second subset of the set of system information messages based at least in part on a channel condition at the UE and the first parameter.

2. The apparatus of claim 1, wherein the first message configuration and the second message configuration have at least one configuration element that is different, and the at least one configuration element includes one or more of a modulation and coding scheme, a quantity of occupied time resources, a quantity of occupied frequency resources, a transmission power, or any combinations thereof.

3. The apparatus of claim 1, wherein the processor is further configured to:
defer an attempt to decode a first system information message of the first subset of the set of system information messages based at least in part on the channel condition at the UE being below a threshold value associated with the first parameter; and
decode a second system information message of the second subset of the set of system information messages based at least in part on the channel condition at the UE being below the threshold value associated with the first parameter.

4. The apparatus of claim 3, wherein the first parameter is a reference signal received power of a reference signal included in the synchronization signal block.

5. The apparatus of claim 1, wherein the processor is further configured to:
decode a master information block from the synchronization signal block, wherein the first parameter is included in the master information block.

6. The apparatus of claim 5, wherein the first parameter is a flag that indicates an associated system information message is one of the first subset of the set of system information messages or the second subset of the set of system information messages.

7. The apparatus of claim 6, wherein the processor is further configured to:
receive an indication of a threshold value associated with the first parameter, and wherein the flag indicates that the associated system information message is to be decoded if the channel condition at the UE exceeds the threshold value.

8. The apparatus of claim 1, wherein the first parameter is received from a serving cell or from a neighbor cell, and wherein different values of the first parameter indicate that an associated system information message is one of the first subset of the set of system information messages or the second subset of the set of system information messages.

9. The apparatus of claim 1, wherein:
the first subset of the set of system information messages are transmitted in a first subset of a set of time periods, are transmitted via a first subset of a set of beams, or any combinations thereof, and
the second subset of the set of system information messages are transmitted in a second subset of the set of time periods, are transmitted via a second subset of the set of beams, or any combinations thereof.

10. The apparatus of claim 1, further comprising an antenna configured to:
receive a control channel message associated with the system information message from one of the first subset of the set of system information messages or the second subset of the set of system information messages, wherein a first subset of control channel messages associated with the first subset of the set of system information messages have a first set of control channel parameter values, and a second subset of control channel messages associated with the second subset of the set of system information messages have a second set of control channel parameter values that is different from the first set of control channel parameter values.

11. The apparatus of claim 1, wherein the set of system information messages include a first subset of the set of system information messages that each include a first quantity of system information parameters and a second subset of the set of system information messages each include a second quantity of system information parameters, and wherein the first quantity of system information parameters is different from the second quantity of system information parameters.

12. The apparatus of claim 11, wherein the first quantity of system information parameters is less than the second quantity of system information parameters, and provide system information for access control procedures, random access channel procedures, or any combinations thereof.

13. An apparatus for wireless communication at a user equipment (UE), comprising:
a processor; and
memory coupled with the processor, the processor configured to:
receive a synchronization signal block that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages includes a second quantity of system information parameters, and wherein the first quantity of system information parameters is different from the second quantity of system information parameters;
receive a first system information message of the first subset of the set of system information messages; and
transmit a first channel access message based at least in part on one or more system information parameters of the first quantity of system information parameters.

14. The apparatus of claim 13, wherein the first subset of the set of system information messages are transmitted in a first subset of a set of time periods, are transmitted via a first subset of a set of beams, or any combinations thereof.

15. The apparatus of claim 13, wherein the first quantity of system information parameters is less than the second quantity of system information parameters, and provide system information for access control procedures, random access channel procedures, or any combinations thereof.

16. The apparatus of claim 13, wherein the first subset of the set of system information messages provide an indication of a location of one or more of the second subset of the set of system information messages.

17. The apparatus of claim 13, further comprising an antenna configured to:
receive configuration information that indicates the first subset of the set of system information messages and the second subset of the set of system information messages, the configuration information received in one or more of a master information block, a radio resource control transmission, a control information transmission, or any combinations thereof.

18. The apparatus of claim 13, wherein the set of system information messages further include a third subset of the set of system information messages, each system information message of the third subset of the set of system information messages includes a third quantity of system information parameters that is different from the first quantity of system information parameters and the second quantity of system information parameters, and wherein a combination of two or more of the first quantity of system information parameters, the second quantity of system information parameters, or the third quantity of system information parameters, provide a set of system information parameters.

19. The apparatus of claim 13, wherein the one or more parameters include at least a first parameter that indicates the first subset of the set of system information messages has a first transmission configuration and the second subset of the set of system information messages has a second transmission configuration, and wherein the first system information message is received via one of the first subset of the set of system information messages or the second subset of the set of system information messages based at least in part on a channel condition at the UE and the first parameter.

20. The apparatus of claim 19, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

21. The apparatus of claim 19, wherein the first parameter is a reference signal received power of a reference signal transmitted in the synchronization signal block.

22. The apparatus of claim 13, wherein:
one or more system information messages of the first subset of the set of system information messages are transmitted in a first subset of a set of time periods, are transmitted via a first subset of a set of beams, or any combinations thereof, and
one or more system information messages of the second subset of the set of system information messages are transmitted in a second subset of the set of time periods, are transmitted via a second subset of the set of beams, or any combinations thereof.

23. The apparatus of claim 13, wherein the processor is further configured to:
receive a control channel message associated with the first system information message, wherein a first subset of control channel messages associated with the first subset of the set of system information messages have a first set of control channel parameter values, and a second subset of control channel messages associated with the second subset of the set of system information messages have a second set of control channel parameter values that is different from the first set of control channel parameter values.

24. An apparatus for wireless communication at a network entity, comprising:
a processor; and
memory coupled with the processor, the processor configured to:
output a synchronization signal block that indicates one or more parameters for a set of system information messages, the one or more parameters include at least a first parameter that indicates a first subset of the set of system information messages have a first transmission configuration and a second subset of the set of system information messages have a second transmission configuration;
output a first system information message of the first subset of the set of system information messages based at least in part on the first transmission configuration; and
output a second system information message of the second subset of the set of system information messages based at least in part on the second transmission configuration.

25. The apparatus of claim 24, wherein the first transmission configuration and the second transmission configuration have at least one configuration element that is different, and the at least one configuration element includes one or more of a modulation and coding scheme, a quantity of occupied time resources, a quantity of occupied frequency resources, a transmission power, or any combinations thereof.

26. The apparatus of claim 24, wherein the first parameter is a reference signal received power of a reference signal transmitted in the synchronization signal block.

27. An apparatus for wireless communication at a network entity, comprising:
a processor; and
memory coupled with the processor, the processor configured to:
output a synchronization signal block that indicates one or more parameters for a set of system information messages, wherein the set of system information messages include a first subset of the set of system information messages and a second subset of the set of system information messages, each system information message of the first subset of the set of system information messages includes a first quantity of system information parameters and each system information message of the second subset of the set of system information messages each includes a second quantity of system information parameters, and wherein the first quantity of system information parameters is different from the second quantity of system information parameters;
output a first system information message for the first subset of the set of system information messages; and
obtain a first channel access message based at least in part on one or more system information parameters of the first quantity of system information parameters.

28. The apparatus of claim 27, wherein the first subset of the set of system information messages are transmitted in a first subset of a set of time periods, are transmitted via a first subset of a set of beams, or any combinations thereof.

29. The apparatus of claim 27, wherein the first quantity of system information parameters is less than the second quantity of system information parameters, and provide system information for access control procedures, random access channel procedures, or any combinations thereof.

30. The apparatus of claim 27, wherein the first subset of the set of system information messages provide an indication of a location of one or more of the second subset of the set of system information messages.
